(19) United States
(12) Patent Application Publication
(10) Pub. No.: US 2004/0148279 A1
(43) Pub. Date: Jul. 29, 2004

(54) Scalable distributed hierarchical cache

(76) Inventor: Nir Peleg, Be'er Yacov (IL)

Correspondence Address: SUGHRUE MION, PLLC, 2100 PENNSYLVANIA AVENUE, N.W., SUITE 800, WASHINGTON, DC, 20037, US

(21) Appl. No.: 10/451,187

(22) PCT Filed: Jun. 20, 2001
(86) PCT No.: PCT/US01/19567

(51) Int. Cl. G06F 7/00

(52) U.S. Cl. 707/3

(57) ABSTRACT

A method for a scalable distributed hierarchical cache of a network of nodes is provided. Each piece of cached data is assigned a cached data identifier. The cached data identifier is stored in a cached data identifier directory, and the directory is used to locate (S210), modify (S290) or invalidate cached data (S280). The cached data can be partially overwritten or partially invalidated during the modification process. The dispersion of cached data allows for faster cached data searches and avoids data “hot spots” within the network of nodes.

### CROSS-REFERENCES TO RELATED APPLICATIONS

This application is an application filed under 35 U.S.C. § 111(a), claiming benefit pursuant to 35 U.S.C. § 120 of the filing date of the Provisional Application Serial No. 60/256,917 filed on Dec. 21, 2000, pursuant to 35 U.S.C. § 111(b). The Provisional Application Serial No. 60/256,917 is incorporated herein by reference for all it discloses.

### BACKGROUND OF THE INVENTION

1. Technical Field of the Invention

This invention is related to a method for a scalable distributed hierarchical cache. In particular, the invention provides distributed caching across a network of nodes such that cached data can be accessed without having to broadcast the cached data across the network. The invention also provides updating of cached data stored at various nodes throughout the network. The updates can be full updates of the cached data or partial updates of the cached data. The invention also provides for invalidation of cached data throughout a network.

2. Description of the Related Art

There will now be provided a discussion of various topics to provide a proper foundation for understanding the invention.

Caches are used to speed up data transfer and may be either temporary or permanent. Memory and disk caches are in every computer to speed up instruction execution and data retrieval. These temporary caches serve as staging areas, and their contents can be changed in nanoseconds or microseconds. Caching techniques are often used to speed up existing systems by storing portions of content in relatively small buffers upon access. Performance gains are noticeable when the same content is reused, since cache retrieval is quicker than retrieving form main memory or disk.

Browser caches and Internet caches hold popular Web pages long periods of time and even for the duration, because caching servers constantly update the page with the latest version from the Internet (e.g., web cache and browser caches). In these cases, the cache database is actually a folder on the disk.

A cache server is a dedicated network server or a service within a server that caches information (e.g., web pages) in order to speed up access to information that has already been retrieved by a previous user. Referring to FIG. 1, a cache server is illustrated. A cache server 13 is part of a network comprised of several nodes 1-6. The nodes 1-6 are connected to the cache server 13 via communication links 7-12. The cache server 13 stores information that has been previously retrieved and forwards the previously stored information to the nodes 1-6 when requested.

A web cache is a computer system in a network that keeps copies of the most-recently requested web pages in memory or on disk in order to speed up retrieval. If the next page requested has already been stored in the cache, it is retrieved locally rather than from the Internet. Typically, web caching servers (or caching servers or cache servers) sit inside the company's firewall and enable all popular pages retrieved by users to be instantly available. Since the content of web pages can change, the caching software is always checking for newer versions of the page and downloading them. Pages will be deleted from the cache after a set amount of inactivity.

A facility in a proxy server that caches incoming web pages on the hard disk. If the next page requested by a browser is already in the proxy cache, the page is retrieved locally instead of from the Internet. With proxy caches, the browsers must be configured to use the proxy server.

A reverse proxy cache (i.e., also known as a “server accelerator”) it is a cache server that resides at the web site or ISP rather than at the user's site. All web pages sent back to the browser move through and are stored on the reverse proxy cache. If the next request for a web page has already been stored in the cache, it is retrieved locally, which eliminates upstream traffic for that file.

A transparent cache is a computer system or software within a computer system that determines if a requested page or file has already been stored in memory or on its hard disk. If it has not, the request is sent upstream to its normal destination. The transparent cache sits between the client and server and is invisible to either side. There are also no configuration adjustments required in the browser to use a transparent cache.

Proxy servers are available for common Internet services; for example, an HTTP proxy is used for Web access, and an SMTP proxy is used for e-mail. Proxies generally employ network address translation (NAT), which presents one organization-wide IP address to the Internet. It funnels all user requests to the Internet and sends responses back out to the appropriate users. Proxies may also cache web pages, so that the next request can be obtained locally.

Internet Cache Protocol is a protocol used by one proxy server to query another for a cached Web page without having to go to the Internet to retrieve it. For example, Microsoft supplies a protocol Cache Array Routing Protocol (CARP) that is used by one proxy server to query another for a cached web page without having to go to the Internet to retrieve it. CARP allows arrays of cache servers to be used and managed as a single entity, which avoids redundancy and supports fail-over and load balancing.

Cache coherency requires managing a cache so that data is not lost or overwritten. For example, when data is updated in a cache, but not yet transferred to its target memory or disk, the chance of corruption is greater. Well-designed algorithms that keep track of the cache obtain cache coherency. It is even more critical in symmetric multiprocessing (SMP) where memory is shared by multiple processors.

As systems grow, caches are to grow proportionally if cache effectiveness is to be maintained. However, growing a centralized cache resource indefinitely is not possible since a centralized resource is always limited in bandwidth and capacity.

One potential solution to the problem of centralized caches is the use of distributed caches. Distributed caches, however, are hard to implement and so far have never been implemented in a fully scalable fashion. To date, implementations of distributed caches have only been partially scalable. This is due to the fact that for the caches to be effective, each component (node) in a distributed cache system needs to be aware of which other nodes store which pieces of data. Such knowledge is normally distributed within the system by broadcasting the cached data identifier to all nodes in the system upon caching new data. Broadcast, however, is not scalable since it involves more nodes on bigger systems. Additionally, for the bandwidth to be scalable per data, it is necessary to keep multiple copies of heavily used data in the cache, so hot spots can be avoided.

Referring to FIG. 2, a network with distributed caches is illustrated. The network is comprised of several nodes 14-19 connected to each other through a switch 20. Communications links 21-26 connect the nodes 14-19 to the switch 20. Each node 14-19 has its own cache 14a-19a containing a plurality of files. Alternatively, the cache on each node may contain data blocks that are parts of files. If several of the nodes want to access File 22 in the cache 15a on the node 15, all the requests for File 22 are funneled through the switch 20. If the system illustrated in FIG. 2 was expanded to several hundred nodes, if one of the nodes contained cached data that was heavily used, the data requests would generate a bottleneck. Broadcasting the cached data would also be difficult, since maintaining a current copy of the cached data on each node consumes node resources, as well as system bandwidth.

In an attempt to solve this scalability problem, a hierarchical caching solution has been devised and is described below.

### SUMMARY OF THE INVENTION

The present invention has been made in view of the above circumstances and to overcome the above problems and limitations of the prior art.

Additional aspects and advantages of the invention will be set forth in part in the description that follows and in part will be obvious from the description, or may be learned by practice of the invention. The aspects and advantages of the invention may be realized and attained by means of the instrumentalities and combinations particularly pointed out in the appended claims.

A first aspect of the present invention provides a method for a distributed hierarchical cache on a plurality of networked computer nodes. The method comprises inputting a cached data search request to one of the plurality of networked nodes, and searching a cached data identifier directory stored on the networked node that received the cached data search request and determining if the requested data is cached on the networked node that received the search request. If the requested data is cached on the networked node that received the cached data search request, the method further comprises outputting an acknowledgement signal. If the requested data is not cached on the networked node that received the cached data search request, the method further comprises transmitting the cached data search request to other nodes in the plurality of networked nodes and determining if the requested data is cached on the other nodes in the plurality of networked nodes by searching a cached data identifier directory of at least one other networked node. If the requested data is found cached on at least one of the other nodes in the plurality of networked nodes, the method further comprises retrieving the requested data from its storage location and transmitting the requested data to the networked node that received the cached data search request.

A second aspect of the present invention provides a method for searching a hierarchical distributed cache, wherein the hierarchical distributed cache spread across a plurality of networked nodes, wherein each of the networked nodes are accessed by client processors, and each of the networked nodes comprise a data cache and a cached data identifier directory. The method comprises receiving a cached data search request from a client processor of one of the plurality of networked nodes, and searching a cached data identifier directory of the networked node that received the cached data search request and determining if the requested data is cached on the networked node that received the search request. If the requested data is cached on the networked node that received the cached data search request, the method further comprises outputting an acknowledgement signal to the client processor. If the requested data is not cached on the networked node that received the search request, the method further comprises transmitting the cached data search request to at least one other node in the plurality of networked nodes and determining if the requested data is cached on at least one other networked node by searching a cached data identifier directory of at least one other networked node. If the requested data is found cached on at least one of the other networked node, the method further comprises retrieving the requested data from its storage location and transmitting the requested data to the networked node that received the cached data search request.

A third aspect of the present invention provides a method for searching a hierarchical distributed cache, wherein the hierarchical distributed cache spread across a plurality of networked nodes, wherein each of the networked nodes are accessed by client processors, and each of the networked nodes comprise a data cache and a cached data identifier directory, and each cached data identifier directory lists the cached data identifier associated with each piece of data in a node's data cached. The method comprises receiving a cached data search request from a client processor of one of the plurality of networked nodes, and the cached data search request identifies a cached data identifier to be located. The method further comprises searching a cached data identifier directory of the networked node that received the cached data search request and determining if the requested cached data identifier is listed in the cached data identifier directory on the networked node that received the search request. If the requested cached data identifier is listed in the cached data identifier directory on the networked node that received the cached data search request, the method further comprises outputting an acknowledgement signal to the client processor. If the requested cached data identifier is not listed in the cached data identifier directory on the networked node that received the search request, the method further comprises transmitting the cached data search request to at least one other node in the plurality of networked nodes and determining if the requested cached data identifier is listed in the cached data identifier directory of at least one other networked node by searching a cached data identifier directory of at least one other networked node. If the requested cached data identifier is located on at least one of the other networked node, the method further comprises retrieving the requested data from its storage location indicated by the cached data identifier and transmitting the requested data to the networked node that received the cached data search request.

A fourth aspect of the present invention provides a computer system adapted for a distributed hierarchical cache. The computer system comprises a plurality of networked processors and a memory comprising software instructions adapted to enable the computer system to input a cached data search request to one of the plurality of networked processors, and search a cached data identifier directory stored on the networked processors that received the cached data search request and determining if the requested data is cached on the networked processor that received the search request. If the requested data is cached on the networked processor that received the cached data search request, The software instructions are further adapted to output an acknowledgement signal. If the requested data is not cached on the networked processor that received the cached data search request, the software instructions are further adapted to transmit the cached data search request to other processors in the plurality of networked processors and determine if the requested data is cached on the other processors in the plurality of networked processors by searching a cached data identifier directory of at least one other networked processor. If the requested data is found cached on at least one of the other processors in the plurality of networked processors, the software instructions are further adapted to retrieve the requested data from its storage location and transmitting the requested data to the networked processor that received the cached data search request.

A fifth aspect of the present invention provides a computer program product for a distributed hierarchical cache. The computer program product comprises software instructions for enabling a computer system of networked processors to perform predetermined operations, and a computer readable medium bearing the software instructions. The predetermined operations comprise inputting a cached data search request to one of the plurality of networked processors, and searching a cached data identifier directory stored on the networked processors that received the cached data search request, and determining if the requested data is cached on the networked processor that received the search request. If the requested data is cached on the networked processor that received the cached data search request, the predetermined operations further comprise outputting an acknowledgement signal. If the requested data is not cached on the networked processor that received the cached data search request, the predetermined operations further comprise transmitting the cached data search request to other processors in the plurality of networked processors and determining if the requested data is cached on the other processors in the plurality of networked processors by searching a cached data identifier directory of at least one other networked processor. If the requested data is found cached on at least one of the other processors in the plurality of networked processors, the predetermined operations further comprise retrieving the requested data from its storage location and transmitting the requested data to the networked processor that received the cached data search request.

A sixth aspect of the present invention provides an executable program for a distributed hierarchical cache for a computer system comprised of a plurality of networked processors. The executable program comprises a first executable code portion which, when executed on a computer system, inputs a cached data search request to one of the plurality of networked processors. The executable program further comprises a second executable code portion which, when executed on a computer system, searches a cached data identifier directory stored on the networked processors that received the cached data search request and determining if the requested data is cached on the networked processor that received the search request. The executable program further comprises a third executable code portion which, when executed on a computer system, determines if the requested data is cached on the networked processor that received the cached data search request, outputting an acknowledgement signal. The executable program further comprises a fourth executable code portion which, when executed on a computer system, determines if the requested data is not cached on the networked processor that received the cached data search request, and forwards the cached data search request to other processors in the plurality of networked processors and determining if the requested data is cached on the other processors in the plurality of networked processors by searching a cached data identifier directory of at least one other networked processor. The executable program further comprises a fifth executable code portion which, when executed on a computer system, determines if the requested data is found cached on at least one of the other processors in the plurality of networked processors, and retrieves the requested data from its storage location and transmitting the requested data to the networked processor that received the cached data search request.

A seventh aspect of the present invention provides a method for updating data in a hierarchical distributed cache on a plurality of networked nodes. The method comprises accessing a network node and modifying cached prior data stored on the accessed network node. The method further comprises searching a cached data identifier directory and determining if the accessed node had previously updated other network nodes with the cached prior data. If the cached data identifier directory indicates that other nodes were updated with the cached prior data, the method further comprises transmitting the modified data to those nodes and replacing the cached prior data with the modified data. The method further comprises determining if the accessed node was updated by at least one other network node with the cached prior data, and if yes, transmitting the modified data to the at least one other network node and replacing the cached prior data with the modified data. Finally, the method further comprises issuing an acknowledgement signal indicating modified data has replaced cached prior data.

An eighth aspect of the present invention provides a method for updating data in a hierarchical distributed cache, wherein the hierarchical distributed cache is spread across a plurality of networked nodes, and wherein each of the networked nodes are accessed by client processors, and each of the networked nodes comprise a data cache and a cached data identifier directory. The method comprises accessing network node via a client processor and modifying cached prior data stored on the accessed network node. Next, the method further comprises searching the cached data identifier directory of the accessed node and determining if the accessed node had previously updated other network nodes with the cached prior data. If the cached data identifier directory indicates that other nodes were updated with the cached prior data, the method further comprises transmitting the modified data to those nodes and replacing the cached prior data with the modified data. The method further comprises determining if the accessed node was updated by at least one other network node with the cached prior data, and if yes, transmitting the modified data to the at least one other network node and replacing the cached prior data with the modified data. Finally, the method comprises issuing an acknowledgement signal to the accessed node indicating modified data has replaced cached prior data and receiving the acknowledgement signal at the client processor.

A ninth aspect of the present invention provides a method for updating data in a hierarchical distributed cache, wherein the hierarchical distributed cache spread across a plurality of networked nodes, wherein each of the networked nodes are accessed by client processors, and each of the networked nodes comprise a data cache and a cached data identifier directory, each cached data identifier directory listing the cached data identifier associated with each piece of data in a node's data cached. The method comprises accessing a network node via a client processor attached to the accessed network node and modifying cached prior data stored on the accessed network node. Next, the method comprises searching a cached data identifier directory for a cached data identifier associated with the cached prior data and determining if the accessed node had previously updated other network nodes with the cached prior data. If the cached data identifier directory indicates that other nodes were updated with the cached prior data, the method further comprises transmitting the modified data to those nodes and replacing the cached prior data with the modified data. The method further comprises determining if the accessed node was updated by at least one other network node with the cached prior data, and if yes, transmitting the modified data to the at least one other network node and replacing the cached prior data with the modified data. Finally, the method comprises issuing an acknowledgement signal to the accessed node indicating modified data has replaced cached prior data and receiving the acknowledgement signal at the client processor.

A tenth aspect of the present invention provides a computer system adapted for a distributed hierarchical cache, wherein the computer system comprises a plurality of networked nodes, and at least one memory comprising software instructions adapted to enable the computer system access a network node and modify cached prior data stored on the accessed network node. The software instructions are further adapted to search a cached data identifier directory and determine if the accessed node had previously updated other network nodes with the cached prior data. If the cached data identifier directory indicates that other nodes were updated with the cached prior data, the software instructions are further adapted to forward the modified data to those nodes and replacing the cached prior data with the modified data. Next, the software instructions are further adapted to determine if the accessed node was updated by at least one other network node with the cached prior data, and if yes, transmitting the modified data to the at least one other network node and replacing the cached prior data with the modified data. Finally, the software instructions are further adapted to issue an acknowledgement signal indicating modified data has replaced cached prior data.

An eleventh aspect of the present invention provides a computer program product for modifying data on a distributed hierarchical cache, wherein the computer program product comprises software instructions for enabling a computer system of networked processors to perform predetermined operations, and a computer readable medium bearing the software instructions. The predetermined operations comprise accessing a network processor and modifying cached prior data stored on the accessed network processor. The predetermined operations further comprise searching a cached data identifier directory and determining if the accessed processor had previously updated other network processors with the cached prior data. If the cached data identifier directory indicates that other processors were updated with the cached prior data, the predetermined operations further comprise transmitting the modified data to those processors and replacing the cached prior data with the modified data next, the predetermined operations further comprise determining if the accessed processor was updated by at least one other network node with the cached prior data, and if yes, transmitting the modified data to the at least one other network processor and replacing the cached prior data with the modified data. Finally, the predetermined operations comprise issuing an acknowledgement signal indicating modified data has replaced cached prior data.

A twelfth aspect of the present invention provides an executable program for modifying data on a distributed hierarchical cache for a computer system comprised of a plurality of networked processors. The executable program comprises a first executable code portion which, when executed on the computer system, accesses a network processor and modifies cached prior data stored on the accessed network processor. The executable program further comprises a second executable code portion which, when executed on the computer system, searches a cached data identifier directory and determines if the accessed processor had previously updated other network processors with the cached prior data. If the cached data identifier directory indicates that other processors were updated with the cached prior data, the executable program further comprises a third executable code portion which, when executed on the computer system, forwards the modified data to those processors and replacing the cached prior data with the modified data. The executable program further comprises a fourth executable code portion which, when executed on the computer system, determines if the accessed processor was updated by at least one other network node with the cached prior data, and if yes, forwards the modified data to the at least one other network processor and replaces the cached prior data with the modified data. Finally, the executable program further comprises a fifth executable code portion which, when executed on the computer system, issues an acknowledgement signal indicating modified data has replaced cached prior data.

A thirteenth aspect of the present invention provides a method for invalidating data in a hierarchical distributed cache on a plurality of networked nodes, the method comprising accessing a network node and issuing an invalidation request against the cached identified data stored on the accessed network node. The method further comprises searching a cached data identifier directory and determining if the accessed node had previously updated other network nodes with the cached identified data, and, if the cached data identifier directory indicates that other nodes were updated with the cached identified data, the method comprises transmitting the invalidation request to those nodes. The method further comprises determining if the accessed node was updated by at least one other network node with the cached identified data, and if yes, transmitting the invalidation request to the at least one other network node. Finally, the method comprises issuing an acknowledgement signal indicating the cached identified data is invalidated.

A fourteenth aspect of the present invention provides a method for invalidating data in a hierarchical distributed cache, wherein the hierarchical distributed cache spread across a plurality of networked nodes, wherein each of the networked nodes are accessed by client processors, and each of the networked nodes comprise a data cache and a cached data identifier directory. The method comprises accessing a network node via a client processor and issuing an invalidation request against cached identified data stored on the accessed network node, searching the cached data identifier directory of the accessed node and determining if the accessed node had previously updated other network nodes with the cached identified data. If the cached data identifier directory indicates that other nodes were updated with the cached identified data, the method further comprises transmitting the invalidation request to those nodes. Next, the method comprises determining if the accessed node was updated by at least one other network node with the cached identified data, and if yes, transmitting the invalidation request to the at least one other network node. Finally, the method comprises issuing an acknowledgement signal to the accessed node indicating the cached identified data has been invalidated and receiving the acknowledgement signal at the client processor.

A fifteenth aspect of the present invention provides a method for updating data in a hierarchical distributed cache, wherein the hierarchical distributed cache spread across a plurality of networked nodes, each of the networked nodes are accessed by client processors, each of the networked nodes comprise a data cache and a cached data identifier directory, each cached data identifier directory listing the cached data identifier associated with each piece of data in a node's data cached. The method comprises accessing a network node via a client processor attached to an access node and issuing an invalidation request against cached identified data stored on the accessed network node, searching the cached data identifier directory of the accessed node and determining if the accessed node had previously updated other network nodes with the cached identified data. If the cached data identifier directory indicates that other nodes were updated with the cached identified data, the method further comprises transmitting the invalidation request to those nodes. Next, the method further comprises determining if the accessed node was updated by at least one other network node with the cached identified data, and if yes, transmitting the invalidation request to the at least one other network node. Finally, the method further comprises issuing an acknowledgement signal to the accessed node indicating the cached identified data has been invalidated and receiving the acknowledgement signal at the client processor.

A sixteenth aspect of the present invention provides a computer system adapted for a distributed hierarchical cache, the computer system comprising a plurality of networked nodes, and at least one memory comprising software instructions adapted to enable the computer system to perform the steps of accessing a network node and issuing an invalidation request against cached identified data stored on the accessed network node. The software instructions are further adapted to search a cached data identifier directory and determining if the accessed node had previously updated other network nodes with the cached identified data. If the cached data identifier directory indicates that other nodes were updated with the cached identified data, the software instructions are further adapted to forward the invalidation request to those nodes. The software instructions are further adapted to determine if the accessed node was updated by at least one other network node with the cached identified data, and if yes, transmitting the invalidation request to the at least one other network node. Finally, the software instructions are further adapted to issue an acknowledgement signal indicating the cached identified data has been invalidated.

A seventeenth aspect of the present invention provides a computer program product for modifying data on a distributed hierarchical cache, the computer program product comprising software instructions for enabling a computer system of networked processors to perform predetermined operations, and a computer readable medium bearing the software instructions. The predetermined operations comprise accessing a network processor and issuing an invalidation request against cached identified data stored on the accessed network processor. The predetermined operations further comprise searching a cached data identifier directory and determining if the accessed processor had previously updated other network processors with the cached identified data. If the cached data identifier directory indicates that other processors were updated with the cached identified data, the predetermined operations further comprise transmitting the invalidation request to those processors. Next, the predetermined operations further comprise determining if the accessed processor was updated by at least one other network node with the cached identified data, and if yes, transmitting the invalidation request to the at least one other network processor. Finally, the predetermined operations further comprise issuing an acknowledgement signal indicating the cached identified data has been invalidated.

An eighteenth aspect of the present invention provides an executable program for modifying data on a distributed hierarchical cache for a computer system comprised of a plurality of networked processors. The executable program comprises a first executable code portion which, when executed on the computer system, accesses a network processor and issues an invalidation request against cached identified data stored on the accessed network processor, and the executable program further comprises a second executable code portion which, when executed on the computer system, searches a cached data identifier directory and determines if the accessed processor had previously updated other network processors with the cached identified data. If the cached data identifier directory indicates that other processors were updated with the cached identified data, the executable program further comprises a third executable code portion which, when executed on the computer system, forwards the invalidation request to those processors. Next, the executable program comprises a fourth executable code portion which, when executed on the computer system, determines if the accessed processor was updated by at least one other network node with the cached identified data, and if yes, forwards the invalidation request to the at least one other network processor. Finally, the executable program comprises a fifth executable code portion which, when executed on the computer system, issues an acknowledgement signal indicating that cached identified data has been invalidated.

### BRIEF DESCRIPTION OF THE DRAWINGS

The accompanying drawings, which are incorporated in and constitute a part of this specification illustrate aspects of the invention and, together with the written description, serve to explain the aspects, advantages and principles of the invention. In the drawings,

FIG. 1 illustrates a block diagram of a conventional network employing a cache server;

FIG. 2 illustrates a block diagram of a conventional network with conventional distributed caches;

FIG. 3 illustrates a block diagram of an exemplary network;

FIG. 4 illustrates a basic process flow for the cached data search feature of the present invention;

FIGS. 5A-5C illustrate a more detailed exemplary process flow for the cached data search feature of the present invention;

FIG. 6 illustrates a basic process flow for the cached data modification feature of the present invention;

FIGS. 7A-7E illustrate a more detailed exemplary process flow for the cached data modification feature of the present invention;

FIG. 8 illustrates a basic process flow for the cached data invalidation feature of the present invention; and

FIGS. 9A-9E illustrate a more detailed exemplary process flow for the cached data invalidation feature of the present invention.

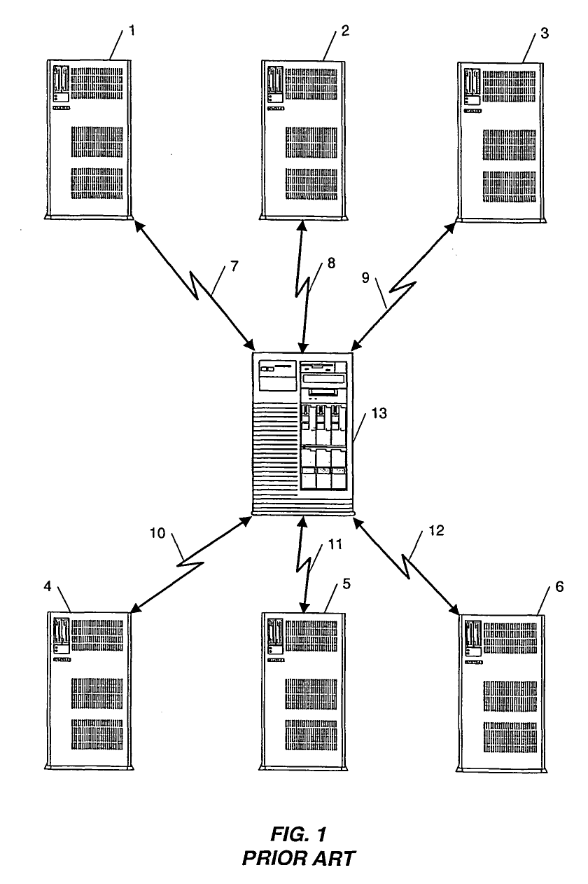

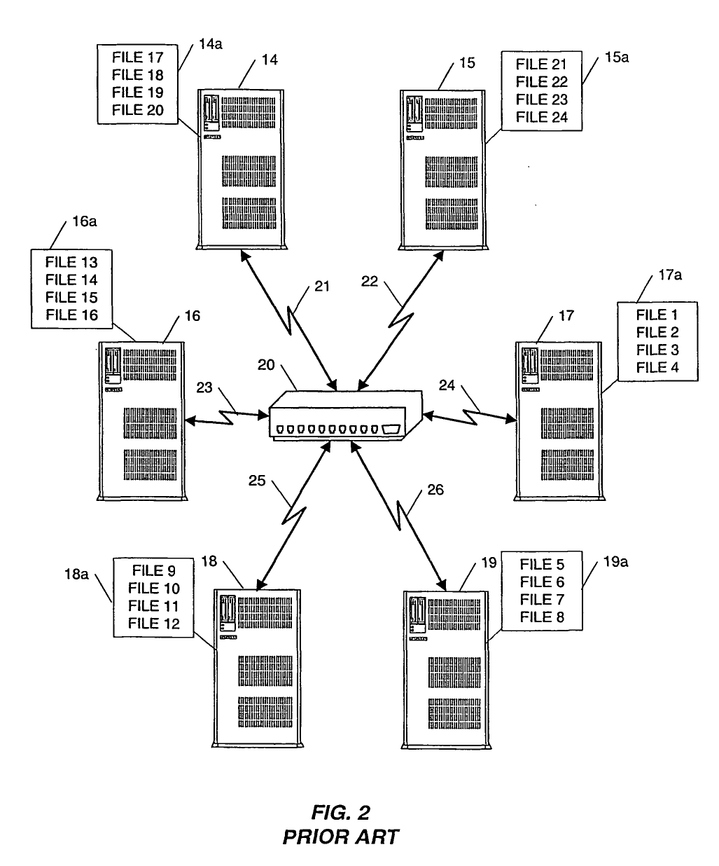

### DETAILED DESCRIPTION OF THE INVENTION

Prior to describing the aspects of the invention, some details concerning the prior art will be provided to facilitate the reader's understanding of the invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

It will be appreciated that the term “predetermined operations,” the term “computer system software,” and the term “executable code” mean substantially the same thing for the purposes of this description. It is not necessary to the practice of this invention that the memory and the processor be physically located in the same place. That is to say, it is foreseen that the processor and the memory might be in separate physical pieces of equipment or even in geographically distinct locations.

As used herein, one of skill in the art will appreciate that “media” or “computer-readable media” may include a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer useable medium, as defined above, which bears instructions for performing predetermined operations in any form.

The present invention will now be described in summary fashion. To avoid broadcast or other non-scalable knowledge distribution techniques, the present invention uses a cached data identifier. Based on the cached data identifier, a tree listing all nodes in the network is to be spanned. The root of the tree and spanning order is derived from the cached data identifier. Per each cached data identifier, the root of the tree will be the “master” node. This means that the root node either stores the (uncached) data associated with the identifier, or knows where that data is stored.

As used herein, the terms “high level node” and “lower level nodes” are used to connote the relationships between the nodes with respect the root node for a particular piece of cached data. For example, if data is being transmitted downtree (i.e., down the spanning tree away from the root node), then the data is being passed from a high level node to a lower level node. Conversely, if data is being forward uptree (i.e., up the spanning tree towards the root node), then the data is being passed from a lower level node to a higher level node. The designation of “high level node” or “low level node” is dependent on the root node for a particular piece of data.

When searching for a cached copy of a particular set of data, any node in the network can be selected as the first node to be searched. If the search of the selected node reveals that the node is caching the requested data, or stores information as to which node is caching the requested data, the search for the requested cached data stops. Otherwise, another node at the next higher level of the spanned tree (i.e., the tree associated with the requested cached data) is consulted. This continues up to the root node (i.e., the root of the tree). Since the root node always knows where the requested data is stored, the search is guaranteed to succeed.

Once the search for the requested data succeeds (either at the root node or at another node), the node at which the search stopped selects (at random or otherwise) one or more of its lower level nodes, and sends them copies of the requested cached data. Please note that the transfer of copies of the cached data to a child node is optional. The search parameters can be set such that, in the case of a read command, a copy of the cached data is sent in the direction of the original requesting node and is cached at the requesting node, and is not cached on any intervening nodes. Alternatively, the transmitted copy of the cached data can be cached at each node along the network path that is traverses from the node where the search was successful back to the original requesting node.

Each high level node that forwards data to a lower level node(s) also updates a cached data identifier directory. The cached data identifier directory maintains a database indicating which lower level node(s) have received copies of which piece of cached data from the high level node. The cached data identifier directory allows the data modification function to determine which lower level nodes have received cached data from the high level node.

This information proliferation function generates a large number of copies of frequently used data. As the usage frequency of a specific data set increases, more and more copies of that data set can be generated at lower levels of the specific data set's spanning tree. When demand for the specific data set decreases, the number of copies of that data set will also decrease due to cache replacement.

Data modification uses a function similar to data search, up to the point where the search succeeds. Once the search for a particular set of cached data succeeds, the cached data at the node at which the search succeeded is modified. In addition, the cached data at nodes that were updated by the node at which the search succeeds (i.e., the lower level nodes) are updated as well. The updating of a cached data set at a node can involve a partial replacement of the cached data set, as well as a wholesale replacement of the data set. In turn, the newly updated lower level nodes update their lower level nodes (if any). This process is repeated until all the nodes that are caching a copy of the data set to be modified have been accessed. Uptree and downtree updates can occur at any order, including in parallel. Each updated node (including the node that is the first to update the level above it, to signify that all its lower level nodes have been updated) acknowledges the modification towards the node that initiated the modification.

When the root node is updated, it modifies the master data set. When the master data set is modified and all the root descendants have acknowledged the modification, the node that initiated the data modification can be acknowledged. That is, an acknowledgement is sent in the direction of the original requesting node after the cached data has been overwritten or modified.

The partial data modification function updates only a portion of the cached data. The partial data modification function passes only the updated data, rather than the entire cached data set stored in memory, to the nodes being updated.

The coalescing of multiple partial data modifications involves merging data among data modification requests. The data modification function also allows for coalescing of data modification requests at higher levels of the tree. This coalescing function eliminates the “hot spot” at the root node (i.e., the root) for very frequently modified data.

The above scheme, as described, is not immune to node faults, since when a node fails, the cached data identifier directory of nodes updated by the failed node is lost. This can be solved in either of two methods:

1. Replicating each node so a single node failure does not affect list availability. This requires recovered nodes to recover the list from their replicated image.

2. Keeping the list in redundant, stable storage (e.g., possibly a non-volatile write cache).

Instead of modifying a particular piece of cached data, a user can request invalidation of a particular piece of cached data at nodes within the network. Rather than modifying a particular piece of cached data with updated information or new information, the cached data is simply invalidated and no longer used. Invalidation of cached data can occur at any order, including in parallel, and the invalidating of cached data occurs in the uptree and downtree directions. After the cached data is invalidated, an acknowledgment signal is sent to the root node. After the root node has collected all the acknowledgement signals, it sends a signal to the node that requested the invalidation so that node can notify the user that the invalidation process is complete.

Data modification includes partial invalidation of cached data. The partial invalidation identifies which portion of the cached data set is to be invalidated. After the identified portion of the cached data is invalidated, an acknowledgment signal is sent to the root node. As described previously, after the root node has collected all the acknowledgement signals, it sends a signal to the node that requested the partial invalidation so that node can notify the user that the partial invalidation process is complete.

A detailed description of the aspects of the invention will now be given referring to the accompanying drawings.

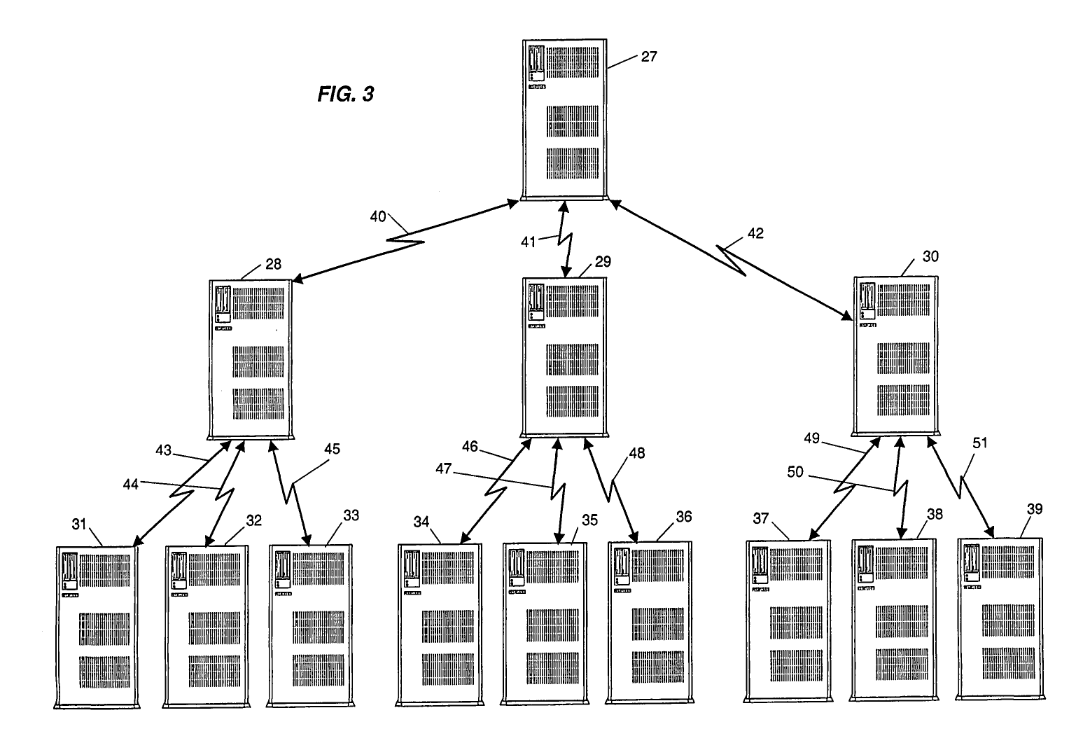

Referring to FIG. 3, a network that utilizes the present invention is illustrated. The network is for exemplary purposes only and does not limit the present invention in any manner. The network comprises a plurality of nodes 27-39 that are interconnected via a series of communication links 40-51. Each of the nodes contains data that is cached. As described above, each piece of cached data has a cached data identifier associated with it, and that cached data identifier indicates the node (i.e., the root node) where the master data set (of which the cached data is a copy) is stored. A cached data identifier also comprises of information regarding the data itself. For example, the cached data identifier can include a file identifier plus a block identifier. This type of cached data identifier would be used for caching a block from within a file. Another type of cached data identifier would comprise a directory identifier plus a file identifier. This type of cached data identifier would be used for caching a file within a directory.

It should be noted that, while the cached data identifier that relates to the root node, the master data set is not necessarily located on the root node. There could be one or more levels of indirection, i.e., the root node will simply store the address (i.e., data pointer) of another node that actually stores the master data set. Alternatively, this other node might also have just the address of yet another node. The levels of indirection will end when the node physically storing the master data set is reached.

Referring to FIG. 3, assume, for example, that a master data set is physically stored on node 28. The cached data identifier would identify node 28 as the root node for this particular data set, and would also delineate where exactly the data set is stored on node 28 (e.g., a directory identifier plus a file identifier). In another example, the master data set may not be physically stored on node 28, but instead be stored on a mass storage device (e.g., a RAID device) that is physically connected to node 28. In this example, the cached data identifier would point to where the data is stored on the mass storage device.

Based on the cached data identifier, a spanning tree listing some or all of nodes in the network is spanned. The root node of the tree and spanning order is derived from the cached data identifier. The branches of the spanned tree extend from the root node.

Spanning algorithms are known, and only a cursory description thereof will be provided. A spanning algorithm is an algorithm used in transparent bridges that dynamically determines the best path from source to destination. The spanning algorithm avoids bridge loops (two or more paths linking one segment to another), which can cause the bridges to misinterpret results. If necessary, the spanning algorithm can create a hierarchical “tree” that “spans” the entire network including all switches. The spanning algorithm determines all redundant paths and makes only one of them active at any given time. The spanning tree protocol (STP) is part of the IEEE 802.1 standard. A spanning tree protocol (STP) message unit, called a Bridge Protocol Data Unit (BPDU), describes the attributes of a switch port such as its MAC address, priority and cost to reach.

Per the cached data identifier, the root node of the spanned tree either stores the master data set (i.e., uncached) associated with the cached data identifier, or knows where the master data set is stored via pointers or other data addressing devices. As noted above, there can be several levels of indirection between the root node and the device physically storing the master data set.

A cached data identifier directory is resident on each node. The cached data identifier directory stores the cached data identifiers associated with each piece of data that is cached on the node. If a new piece of data is to be cached on a node, its cached data identifier is stored in this directory. During a search for a particular piece of cached data, this directory is searched, i.e., the listed cached data identifiers are reviewed to determine if the desired data is cached on the node being searched. If a piece of cached data is invalidated, the cached data identifier is cleared from the directory, so a subsequent search does not incorrectly identify the node as caching the requested data.

1. Cached Data Search

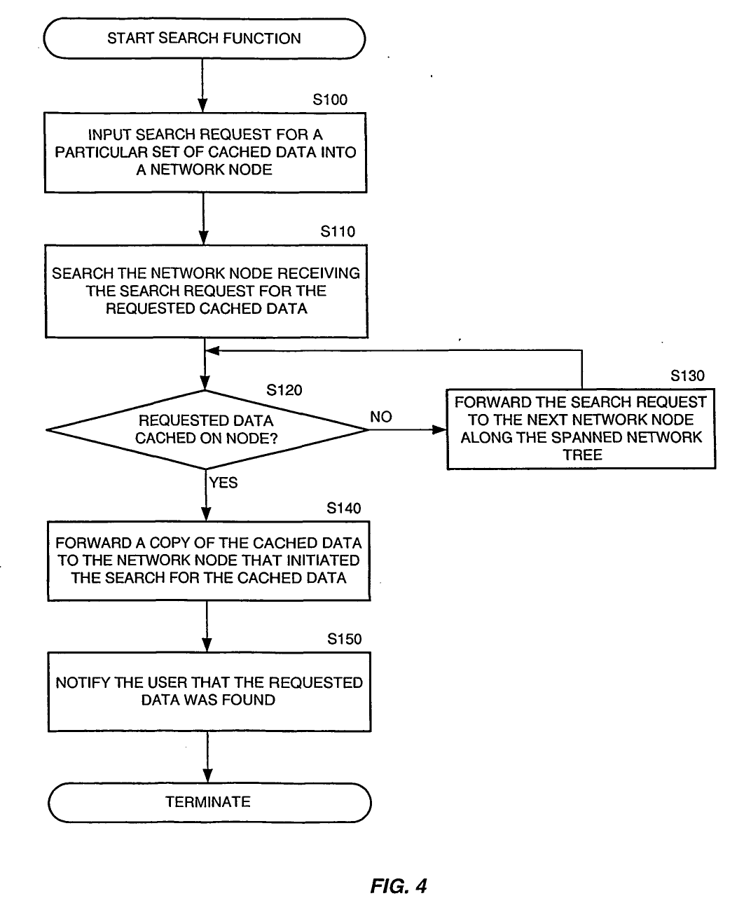

Referring to FIG. 4, an aspect of the present invention will be described in summary fashion. In general, a search request is usually coupled with a data retrieval request or a data modification request. The present invention, however, can just search for requested data without being coupled with a data retrieval request or a data modification request. As described below, a data modification request outputs an acknowledgement signal to the requesting client when the data modification is complete. For a data retrieval request, an acknowledgement signal and the requested data is outputted to the requesting client. At S100, a requestor inputs a search request delineating the particular piece of cached data to be retrieved into a network node. At S110, the network node receiving the search request is searched. If the requested data is not found, at S130, the search request is transmitted to the next higher level network node on a spanned network tree for the requested cached data. This is repeated until the requested data is found, or the root node is reached. At S140, once the requested data is found, it is transmitted to the network node where the search request was input. At S150, if the requested data is found, the search halts and the requestor is notified. Of course, if the requested cached data is not stored on any of the networked nodes or the root node, the requestor is notified that the requested cached data cannot be found on the network.

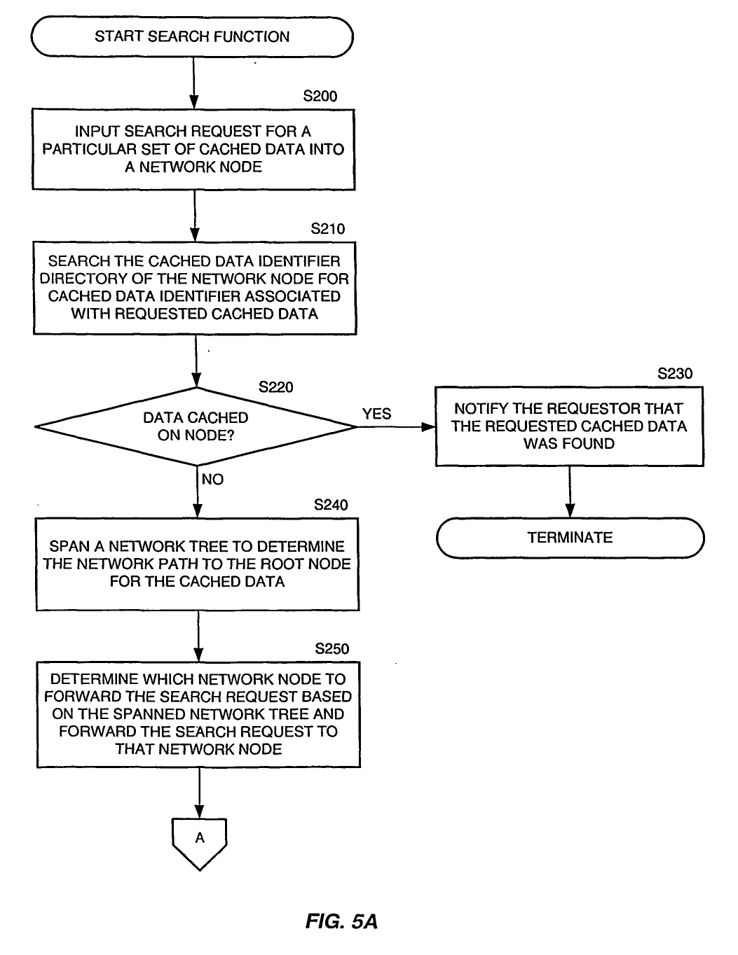

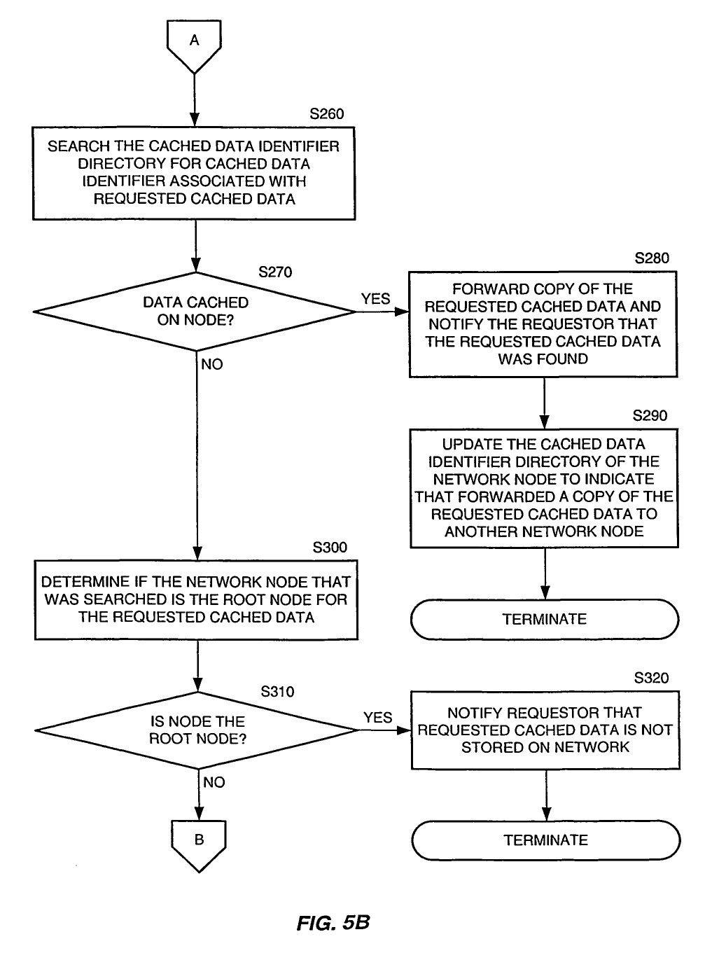

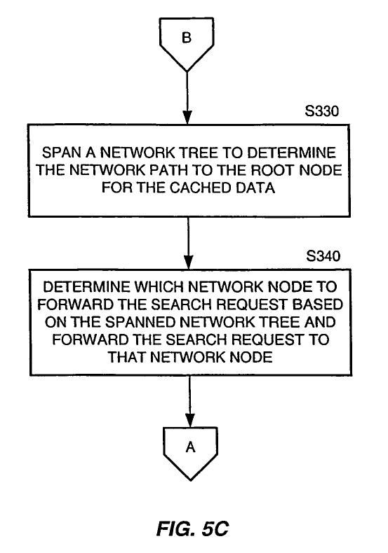

Referring to FIGS. 5A-5C, the search function aspect of the present invention will now be described in greater detail. Referring to FIG. 5A, at S200, the requestor inputs a search request into an accessed node that is part of an interconnected network, such as is shown in FIG. 3. Typically, the search request would be input through a terminal connected to the accessed node. The search request could also be received from a client processor that is attached to the accessed node as well. The search request comprises a cached data identifier that is associated with the requested data. At S210, the accessed node searches through its cached data identifier directory to determine if it is caching the requested data. In other words, the cached data identifier directory is searched for the cached data identifier that is associated with the cached data. At S230, if the cached data identifier is found (i.e., the requested data is cached at the accessed node), then the requestor is notified and the search process terminates. Notifying the requestor can include retrieval of a copy of the found cached data, and transmitting it to the requestor, or sending an acknowledgement signal to the requestor. If a client processor attached to the accessed node sent the search request, then the acknowledgement signal or a copy of the found cached data, or both, would be transmitted to the client processor.

If the requested data is not cached at the accessed node (i.e., the cached data identifier was not found in the cached data identifier directory), then the search request is transmitted to another network node. In order to determine which node to send the search request, at S240, a network tree is spanned using the cached data identifier. At S250, the accessed node uses the spanned network tree to determine which network node receives the search request. The accessed node sends the search request to the network node that is along the network path that leads to the root node indicated by the cached data identifier.

Referring to FIG. 5B, at S260, at the next network node, the cached data identifier directory is reviewed to determine if the requested data is cached on the network node (i.e., the cached data identifier is found in the cached data identifier directory). If the cached data identifier is not found in the cached data identifier directory, at S300, a determination is made whether the network node that was just searched is the root node for the requested cached data. If the searched network node is the root node for the requested cached data and the requested cached data was not found, then at S320, the requestor is notified that the requested data is not stored on the network.

Referring to FIG. 5C, if the searched network node is not the root node for the requested cached data, then, at S330, a network tree is spanned using the cached data identifier. At S340, the accessed node uses the spanned network tree to determine which network node receives the search request. The accessed node sends the search request to the network node that is along the network path that leads to the root node indicated by the cached data identifier. The process flow then returns to S260 to determine if the network node that received the search request has cached the requested cached data.

If the requested data is cached on the searched network node, at S280, a copy of the cached data is transmitted to the requesting node. Please note that the requesting node is not necessarily the accessed node. The requesting node is the network node that transmitted the search request to the network node where the search request was ultimately successful. There can be many “requesting nodes” interposed between the accessed node and the network node where the search was successful.

At S290, the network node that transmitted the requested cached data makes an entry on its cached data identifier directory that it transmitted the requested cached data to the requesting network node. This entry is used later for modifying or invalidating the cached data.

As discussed above, each network node that forwards the requested cached data updates the entry on its own cached data identifier directory corresponding to the requested cached data. Alternatively, a node receiving cached data from a higher level node can generate a new entry in the cached data identifier directory upon receipt of the new data. This alternate method does not rely on the cached data being transmitted to another network node for the entry to be generated in the cached data identifier directory. In addition, a separate directory can also be used to maintain a list of the nodes to which requested cached data was transmitted. In any event, the cached data identifier directory is a “road map” that will assist the data search and data modification features of the present invention determine if a particular piece of cached data is cached on a node, or if it merely passed through the node.

Another embodiment of the search function aspect of the present invention is a computer system that is adapted for a distributed hierarchical cache. Generally, search requests are usually coupled with a data retrieval request or a data modification request. The computer system, however, can just search for requested data without being coupled with a data retrieval request or a data modification request. As described below, a data modification request outputs an acknowledgement signal to the requesting client when the data modification is complete. For a data retrieval request, an acknowledgement signal and the requested data is outputted to the requesting client. In general, the computer system comprises a plurality of processors (i.e., nodes) that are networked together in some fashion. Within the computer system, there is at least one memory that comprises software instructions that are adapted to enable the computer system to execute the search function aspect of the present invention. The software instructions are adapted to enable the inputting a cached data search request to one of the plurality of networked processors. As described above, the cached data search request is associated with a cached data identifier.

Each processor in the network has a cached data identifier directory as described above. The software instructions are further adapted to search the cached data identifier directory stored on the networked processor that received the cached data search request. The software instructions determine if the requested data is cached on the networked processor that received the search request. As described above, the adapted software instructions execute a search through the cached data identifier directory to determine if the cached data identifier associated with the search data request is present.

If the adapted software instructions determine that the requested data is cached on the networked processor that received the cached data search request, the software instructions output an acknowledgement signal. It is not necessary to transfer data since the requested data is already resident on the searched networked processor.

However, if the adapted software instructions determine that the requested data is not cached on the networked processor that received the cached data search request, the software instructions forward the cached data search request to other processors in the plurality of networked processors. The transmitting of the cached data search request is done in accordance with the tree spanning as described above. The software instructions determine if the requested data is cached on the other processors in the plurality of networked processors by searching a cached data identifier directory of at least one other networked processor. Again, the selection of the networked processors to search for the cached data identifier is determined by the spanned tree for the particular piece of data that is requested.

If the adapted software instructions find the requested data cached on at least one of the other processors in the plurality of networked processors, the adapted software instructions retrieve the requested data from its storage location. After retrieving the data, the adapted software instructions transmit the requested data to the networked processor that received the cached data search request, along with an acknowledgement signal.

The adapted software instructions also update the cached data identifier directory on the transmitting processor and each of the processors in the pathway between the transmitting processor and the networked processor that received the cached data search request. This creates a “roadmap” that is used by the modification and invalidation features of the present invention to locate all the processors where a particular piece of data is cached. The adapted software instructions can also cache the requested data on each processor on the pathway between the transmitting processor and the networked processor that received the cached data search request. This caching of the requested data is an optional, and also reduces the search time for a particular piece of cached data.

Another embodiment of the search function aspect of the present invention is a computer program product for a distributed hierarchical cache. Generally, search requests are usually coupled with a data retrieval request or a data modification request. The computer program product, however, can just search for requested data without being coupled with a data retrieval request or a data modification request. As described below, a data modification request outputs an acknowledgement signal to the requesting client when the data modification is complete. For a data retrieval request, an acknowledgement signal and the requested data is outputted to the requesting client. The computer program product comprises software instructions that enable a computer system of networked processors to perform predetermined operations. The software instructions are borne on a computer readable medium (e.g., floppy disk, CD, ROM, etc.). The predetermined operations performed by the networked processors comprise receiving a cached data search request to one of the plurality of networked processors. As described above, the cached data search request is associated with a cached data identifier.

Each processor in the network has a cached data identifier directory as described above. The predetermined operations, performed by the networked processor that received the cached data search request, will search the cached data identifier directory stored on the networked processor that received the cached data search request. The predetermined operations will determine if the requested data is cached on the networked processor that received the search request. As described above, the predetermined operations will execute a search through the cached data identifier directory to determine if the cached data identifier associated with the search data request is present.

If the predetermined operations determine that the requested data is cached on the networked processor that received the cached data search request, an acknowledgement signal will be output. It is not necessary to transfer data since the requested data is already resident on the searched networked processor.

However, if the predetermined operations determine that the requested data is not cached on the networked processor that received the cached data search request, the predetermined operations will transmit the cached data search request to other processors in the plurality of networked processors. The transmitting of the cached data search request is done in accordance with the tree spanning as described above. The predetermined operations will determine if the requested data is cached on the other processors in the plurality of networked processors by searching a cached data identifier directory of at least one other networked processor. Again, the selection of the networked processors to search for the cached data identifier is determined by the spanned tree for the particular piece of data that is requested.

If the predetermined operations find the requested data cached on at least one of the other processors in the plurality of networked processors, the requested data will be retrieved from its storage location. After retrieving the data, the predetermined operations will transmit the requested data to the networked processor that received the cached data search request, along with an acknowledgement signal indicating that the cached data search request was successful.

Another embodiment of the search function aspect of the present invention is an executable program for a distributed hierarchical cache for a computer system comprised of a plurality of networked processors. The executable program comprises several portions of executable code that are targeted to performing specific tasks when executed on the computer system. In general, search requests are usually coupled with a data retrieval request or a data modification request. The executable program, however, can just search for requested data without being coupled with a data retrieval request or a data modification request. As described below, a data modification request outputs an acknowledgement signal to the requesting client when the data modification is complete. For a data retrieval request, an acknowledgement signal and the requested data is outputted to the requesting client. The first executable code portion, when executed on the computer system, inputs a cached data search request to one of the plurality of networked processors. The cached data search request can come from a terminal attached to one of the networked processors, or be sent by a client processor that is attached to one of the networked processors.

The executable program further comprises a second executable code portion, when executed on the computer system, searches a cached data identifier directory stored on the networked processor that received the cached data search request and determines if the requested data is cached on the networked processor that received the cached data search request. As described above, if the cached data identifier is not found in the cached data identifier directory, then the cached data associated with the identifier is not cached on the processor.

The executable program further comprises a third executable code portion which, when executed on the computer system, determines if the requested data is cached on the networked processor that received the cached data search request. If the cached data is indeed stored on the networked processor, the third executable program outputs an acknowledgement signal. It is not necessary to transfer the cached data since it is reside on the networked processor that received the cached data search request.

The executable program further comprises a fourth executable code portion which, when executed on the computer system, determines if the requested data is not cached on the networked processor that received the cached data search request, and forwards the cached data search request to other processors in the plurality of networked processors and determines if the requested data is cached on the other processors in the plurality of networked processors by searching a cached data identifier directory of at least one other networked processor. As described above, the transmitting of the cached data search request is determined by the spanned tree associated with the root networked processor of the particular piece of data that is requested.

Finally, the executable program further comprises a fifth executable code portion which, when executed on the computer system, determines if the requested data is cached on at least one of the other processors in the plurality of networked processors. If the data is cached on at least one of the other processors in the plurality of networked processors, the fifth executable code portion retrieves the requested data from its storage location. The requested data is transmitted to the networked processor that received the cached data search request, along with an acknowledgement signal that indicates that the cached data search was successful.

Another feature of the search function is that the process selects a predetermined number that are located below the searched node (i.e., lower level nodes) in the tree to receive additional copies of the requested cached data. The requested cached data that was retrieved from its storage location is stored on these selected nodes. This is an optional feature of the search function, and the dispersal of requested cached data to other nodes in the network assists in later searches for the data. The requestor, when invoking the search function, can select whether or not the search function to disperses the retrieved data to other lower-level nodes of the node where the search was successful.

2. Cached Data Modification

The present invention also provides for the modification and updating of cached data stored on various nodes in the network. For purposes of clarity in the following description, data cached at a node prior to its modification with new information will be referred to as “prior data” and cached data that has been subsequently modified with the new information will be referred to as “modified data.” It will be appreciated that cached prior data may have been previously modified several times. In the context of describing the modification and updating of cached data, however, prior data represents the cached data just before modification, and modified data represents the cached data subsequent to modification. There are at least two modification/update scenarios that must be considered. The first scenario involves the modification of the master data set stored at the root node, and the subsequent updating of the cached prior data (i.e., the copies of the master data set) stored at other nodes in the network. The second scenario involves the modification of cached prior data stored on a node other than the root node and subsequent updating of the cached prior data stored at other nodes in the network, including the master data set at the root node.

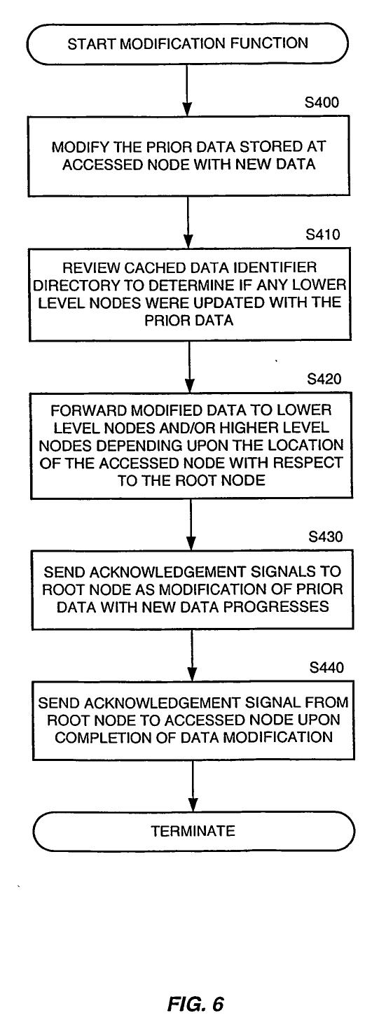

Referring to FIG. 6, the data modification scenario will be described in summary fashion. At S400, the prior data stored at accessed node is modified and the now-modified prior data (i.e., “modified data”) is stored back on the accessed node. At S410, the cached data identifier directory is consulted to determine which lower level nodes received copies of the prior data. Please note that the terms “lower level node” and “higher level node” connote a direction through the network pathways with regard to the root node. At S420, the modified data is sent to higher level nodes as well as lower level nodes that have received copies of the prior data, depending upon the accessed node's location in the network with respect to the root node. At S430, as the modification of the prior data with the new data progresses, the various network nodes that are caching prior data send acknowledgement signals to the root node after the modification is complete. At S440, when the root node has collected all the acknowledgement signals from the network nodes that cache the now-modified prior data, the root node sends an acknowledgement to the user at the accessed node that the prior data has been successfully modified.

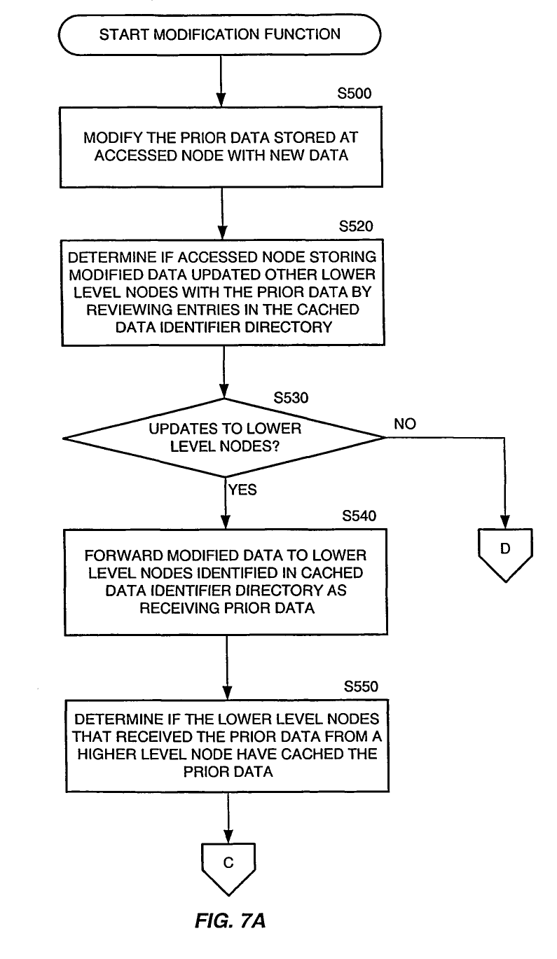

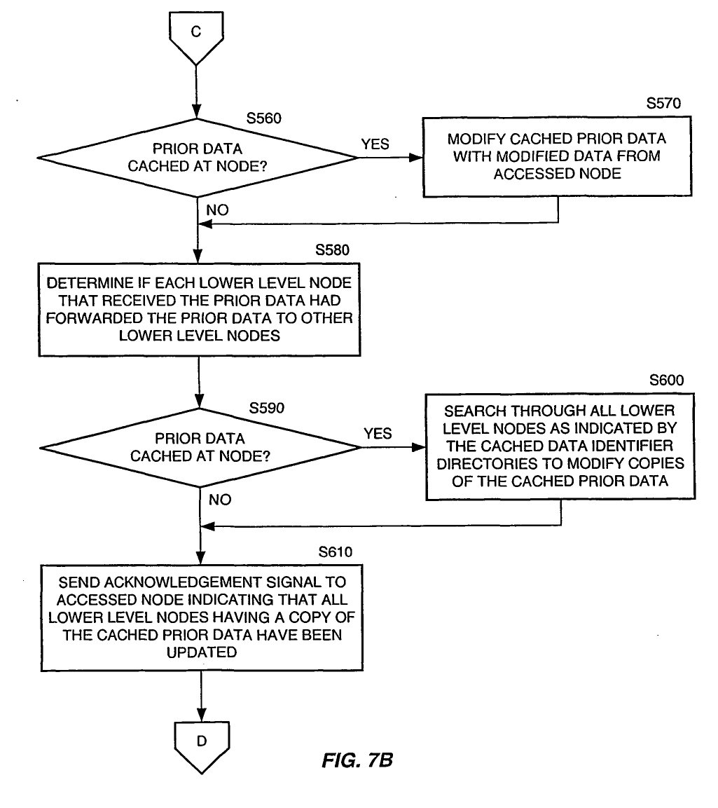

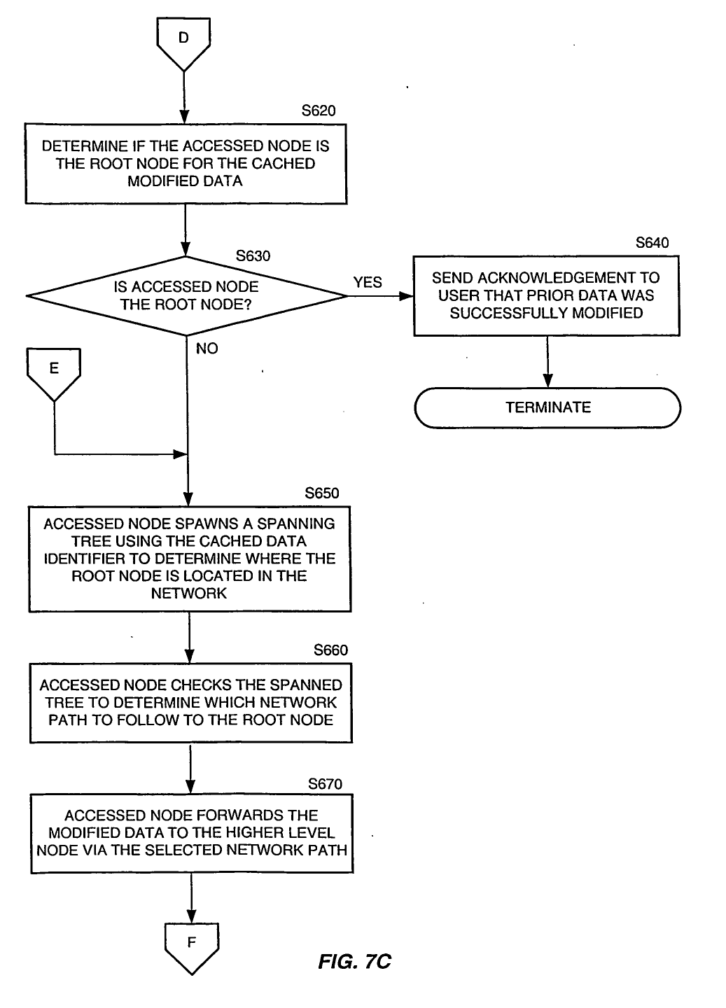

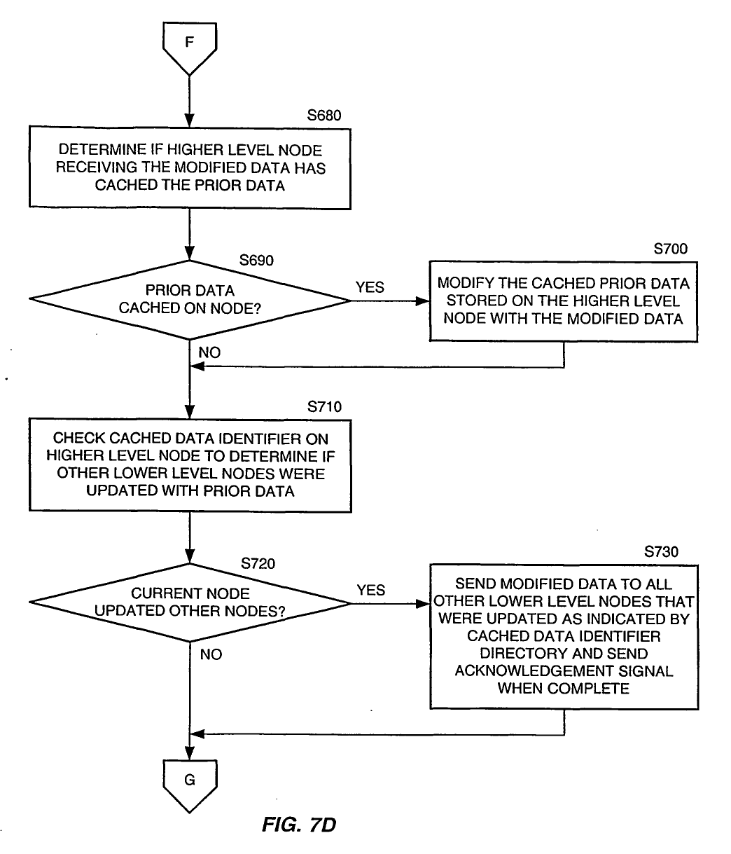

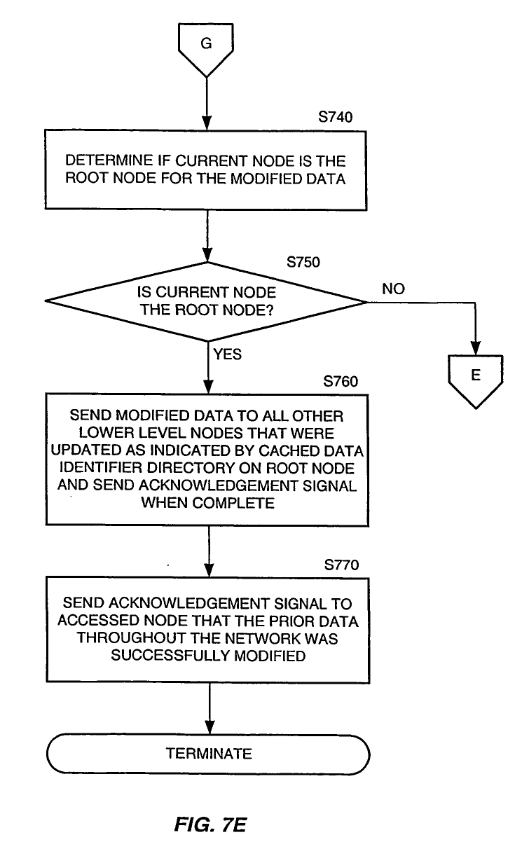

Referring to FIGS. 7A-7D, the data modification feature will be discussed in greater detail. Referring to FIG. 7A, at S500, a network node is accessed and the prior data cached at the accessed node is modified with new data. As noted above, the now-modified prior data (i.e., “modified data”) has a cached data identifier associated with it, and the cached data identifier is stored in the cached data identifier directory resident on the accessed node. If the accessed node is the root node, the modified data is stored on the root node, cached on the root node, or stored at a location indirectly pointed to by the cached data identifier associated with the modified data. For purposes of this description, it is understood that when modified data is transmitted from one node to update the prior data on another node, the modified data overwrites the cached prior data. However, it is appreciated that only the modified portion of the prior data can be transmitted for modification purposes to other nodes as well.

At S520, a determination is made whether the accessed node caching the modified data updated any other lower level nodes with the prior data. The cached data identifier directory described earlier for keeping track of lower level nodes that are updated with prior data is used. As described previously, each node keeps a cached data identifier directory enumerating the lower level nodes that have received a copy of the prior data. For example, referring to FIG. 3 and assuming the root node for a particular piece of data is node 28, the cached data identifier directory of node 28 would identify node 27 and nodes 31-33 as lower level nodes if those nodes had received copies of the prior data for which node 28 is the root node. Furthermore, if a copy of the same prior data had been transmitted from node 27 to node 30, the cached data identifier directory would indicate that lower level node 30 received a copy of the prior data.

Referring to FIG. 7A, if cached data identifier directory indicates no lower level nodes received any copies of the now-modified prior data, the modification process proceeds to S620. If any lower level node received a copy of the prior data, at S540, the modified data is sent to the lower level nodes identified in the cached data identifier directory on the accessed node as having received a copy of the prior data. At S550, each lower level node receiving the modified data from the accessed node determines whether it cached the prior data that was previously transmitted to it from the accessed node.

Referring to FIG. 7B, if the lower level node has cached the prior data, at S570, the node overwrites the cached prior data with the modified data, thus creating cached modified data. As noted before, the cached prior data may be completely overwritten with the new data, or the only modified portion of the prior data can be used to overwrite the corresponding portion of the cached prior data. Next, at S580, each network node determines if it previously transmitted the now-modified cached prior data to the next level of lower level nodes (i.e., their child nodes). If the lower level nodes previously transmitted the now-modified cached prior data to other lower level nodes, the, at S600, the data modification feature searches through those branches that spread out from a particular network node to find and modify all copies of the cached prior data. The modification process is repeated downtree until all network nodes that are lower level nodes to the accessed node have been updated with the modified data.

An acknowledgement signal process executes in parallel with the modification process. Once the modification process has been completed on all lower level nodes and their child nodes, at S610, the lower level nodes send an acknowledgement signal to the accessed node. This acknowledgment signal lets the accessed node that the updating process is complete. Referring to FIG. 3, for example, assume that the root node for a particular piece of cached data is node 31 and copies of the data are cached on nodes 27, 28, 29, 37 and 39. Each of those nodes will transmit an acknowledgement signal to the root node 31. If the accessed node is node 28, and the cached prior data on node 28 is modified, then after node 28 sends out the modified data to node 27, it waits for an acknowledgment signal from node 27 indicating that node 27 and its lower level nodes have been updated. Since node 27 has updated other nodes (i.e., nodes 29, 37 and 39), it has to wait for acknowledgement signals from those nodes indicating that the original cached data was modified appropriately before sending its acknowledgement signal to node 28. If the accessed node is not the root node, the acknowledgement signal travels uptree with the modified data to the higher level nodes.

Referring to FIG. 7C, at S620, a determination is made whether the accessed node is the root node for the particular piece of cached modified data. If the accessed node is the root node, at S640, an acknowledgement signal is sent to the user that initiated the data modification indicating that the modification of the prior data with new data was successful throughout the network.

If the accessed node is not the root node, then the accessed node must have received the cached prior data from a higher level node (i.e., at least one other node in the pathway between the accessed node and the root node for the cached prior data). The cached data identifier stored in the cached data identifier directory on the accessed node contains the identification of the root node that stores the prior data. If the accessed node is not the root node, at S650, the accessed node spans a spanning tree to determine where in the network the root node for the now-modified prior data is located. At S660, the accessed node checks the spanned tree to determine which network path to follow to the root node. Please note that for some network architectures, there is the possibility of multiple network paths, and therefore the most direct path to the root node should be followed. At S670, the accessed node forwards the modified data to the selected higher level node using the selected network path.

Referring to FIG. 7D, at S680, after receiving the modified data, the higher level node checks to see if it has cached the prior data. If so, at S700, the higher level node overwrites or modifies the prior data with the modified data. At S710, the higher level node determines whether it updated other lower level nodes with the prior data by examining the cached data identifier stored on the higher level node. This is done to ensure all the branches of the network are checked for prior data that was transmitted to other nodes further downtree. If the parent node updated its child nodes with the prior data, at S730, the parent node starts the updating process for lower level nodes described above, and waits for an acknowledgement signal from the lower level nodes that the updating process is complete.

Referring to FIG. 7E, at S740, a determination is made whether the current node is the root node for the modified data. The current node checks the cached data identifier associated with the modified data, since the cached data identifier contains information about the root node for the modified data. If the current node is not the root node, then the modification process returns to S650 and starts the spanning and transmitting process again. The uptree modification process is continued until the root node is reached and the prior data stored on the root node is updated with the modified data, and the appropriate acknowledgement signals are sent back to the root node. It is possible that when the root node has been reached and updated, it has other lower level nodes that received the prior data and have not yet been modified. Therefore, at S760, the modification process proceeds down those network branches until all the copies of the cached prior data have been located and updated.

At S770, when the root node has received all the acknowledgement signals from its lower level nodes, the root node forwards an acknowledgment signal to the accessed node that the modification process is complete. Typically, the accessed node sends an acknowledgment to the user that the modified data has been successfully updated on all other nodes that cached the prior data, and that the prior data stored on the root node has been updated as well.

Referring to FIG. 3, a modification/update scenario will be further described. For purposes of this example, it is assumed that node 27 is the root node for the prior data. It is further assumed that node 28, node 36 and node 3S have cached a copy of the prior data.

As described above, a user accesses node 27 and modifies one of the pieces of prior data stored on node 27. After the modification process is completed, node 27 determines if the now-modified prior data had been previously sent to other nodes in the network. As described above, node 27 reviews a cached data identifier directory that keeps track of which lower level nodes received which pieces of prior data. Since copies of the prior data are resident on node 28, node 36 and node 38, the cached data identifier directory would indicate that node 28, node 36 and node 38 each received a copy of the prior data. This does not mean that each of those nodes actually cached that prior data, but only means that the prior data was transmitted to that particular node.

For node 28, the update process is rather straightforward, as outlined above. Node 27 forwards the now-modified prior data to node 28, whereupon the cached copy of the prior data is overwritten or modified. Upon completion of the overwrite/modification process, an acknowledgement signal is sent to node 27 from node 28. The user is not notified yet, since the prior data was transmitted to three child nodes and node 27 will wait for acknowledgement signals from nodes 28-30 before notifying the user that the update to the cached prior data was successful.

Node 27 also forwards a copy of the now-modified prior data to node 29 and node 30. Neither of these nodes has cached a copy of the prior data. Each of these nodes, however, has transmitted a copy of the prior data to at least one of its child nodes. Therefore, on node 29, the cached data identifier directory is reviewed and a determination made which node received the copy of the prior data. In the example, node 36 received a copy of the prior data from node 29. Therefore, node 29 forwards the copy of now-modified prior data to the node 29, and node 36 sends back an acknowledgement signal to node 29 when the cached prior data is overwritten and/or modified. Node 29 passes the acknowledgement signal to node 27. The same process occurs with respect to node 30 and the prior data cached on node 38. After node 27 receives the all the acknowledgement signals, it sends a message to the user that the cached prior data was successfully updated throughout the network.

Referring to FIG. 3, another modification/update scenario will be further described. For purposes of this example, it is assumed that node 27 is the root node for the prior data. It is further assumed that node 28, node 36 and node 38 have cached a copy of the prior data.

A user accesses node 36 and modifies one of the pieces of prior data cached on node 36. After the modification process is completed, node 36 spans the network to determine its higher level nodes in order to get to the root node. The spanning tree will indicate that the higher level node of node 36 is node 29. The cached data identifier denotes that the root node for this particular piece of cached data is node 27.

At node 29, a determination is made whether any of the other lower level nodes of node 29 were updated with the prior data from node 27. If updates were found, the cached prior data would be updated with the now-modified prior data, and an acknowledgement signal would be received from the lower level node(s). In this example, the other lower level nodes of node 29 (i.e., nodes 34-35) never received the prior data, so node 29 does not transmit the now-modified prior data to those nodes.

Next, node 29 spans a tree to see if the root node is a higher level node. Since the spanning tree indicates that the root node is a higher level node, the now-modified prior data is transmitted to the root node. After node 27 updates the uncached prior data with the now-modified prior data, it checks its cached data identifier directory to determine if any of its other lower level nodes received a copy of the prior data. Please note that node 27 will likely have a copy of the modified data in it's cache. Its cached data identifier directory would indicate that, other than node 29 (and indirectly node 36), node 28 and node 30 received the prior data as well.

The cached prior data on node 28 and node 38 will be updated as discussed above, and each node will send back acknowledgement signals that will be collected at node 27. When node 27 has received acknowledgement signals from all the lower level nodes that it updated, node 27 will send an acknowledgement signal to node 36 through node 29. When node 36 receives the acknowledgement from node 29, it sends a message to the user that the cached prior data was successfully updated throughout the network.

Referring to FIG. 3, another modification/update scenario will be further described. This process is repeated both uptree as well as downtree in order to ensure all the cached prior data is overwritten or modified. For purposes of this example, it is assumed that node 27 is the root node for the prior data. It is further assumed that node 28, node 30, node 36 and node 38 have cached a copy of the prior data.

As described above, a user accesses node 30 and modifies one of the pieces of prior data cached on node 30. The cached data identifier directory is reviewed and the modified data is sent to node 38, since the directory indicates that node 38 received a copy of the prior data. Node 38 sends an acknowledgement signal to node 30 after it modifies its cached prior data since there are no lower level nodes connected to node 38.

After the lower level node modification process is completed, node 30 spans the network to determine its higher level nodes in order to get to the root node. The spanning tree will indicate that the higher level node of node 30 is node 27. The cached data identifier denotes that the root node for this particular piece of cached data is node 27. Node 30 forwards the modified data to node 27 along with the acknowledgement signal indicating that it and all its lower level nodes have been updated.

After node 27 updates the uncached prior data with the now-modified prior data, it checks its cached data identifier directory to determine if any of its other child nodes received a copy of the prior data. Its cached data identifier directory would indicate that, other than node 30, node 28 and node 29 (and indirectly node 36) received the prior data as well. Those nodes are updated with the now-modified data and send acknowledgement signals back to node 27, which sends an acknowledgement signal to node 30 once it has received acknowledgement signals from all its lower level nodes. When node 30 receives the acknowledgement signals from node 27 and node 38, it sends a message to the user that the cached prior data was successfully updated throughout the network.

Another embodiment of the data modification aspect of the present invention is a computer system that is adapted for a distributed hierarchical cache. In general, the computer system comprises a plurality of processors (i.e., nodes) that are networked together in some fashion. Within the computer system, there is at least one memory that comprises software instructions that are adapted to enable the computer system to execute the data modification aspect of the present invention. As described above, the cached data modification request is associated with a cached data identifier.

Each processor in the network has a cached data identifier directory as described above. The software instructions are adapted to access a network node and modify cached prior data stored on the accessed network node. The software instructions are further adapted to search a cached data identifier directory and determine if the accessed node had previously updated other network nodes with the cached prior data. If the analysis of the cached data identifier directory indicates that other nodes were updated with the cached prior data, the software instructions are further adapted to transmit the modified data to those identified network nodes and replace the cached prior data with the modified data.

Next, the software instructions are adapted to determine if at least one other network node updated the accessed node with the cached prior data. If the accessed node was updated by another networked node, the software instructions are further adapted to transmit the modified data to the other network node and replace the cached prior data with the modified data. Finally, the software instructions are further adapted to issue an acknowledgement signal indicating modified data has replaced cached prior data. The acknowledgement signal will not be issued until all the cached prior data has been successfully updated with the modified data.

Another embodiment of the data modification aspect of the present invention is a computer program product for a distributed hierarchical cache. The computer program product comprises software instructions that enable a computer system of networked processors to perform predetermined operations. The software instructions are borne on a computer readable medium (e.g., floppy disk, CD, ROM, etc.). The predetermined operations performed by the networked processors comprise receiving a cached data modification request to one of the plurality of networked processors. As described above, the cached data modification request is associated with a cached data identifier.

each processor in the network has a cached data identifier directory as described above. The predetermined operations, performed by the networked processor that received the cached data modification request, access a network processor and modify cached prior data stored on the accessed network processor. The predetermined operations search a cached data identifier directory and determine if the accessed processor had previously updated other network processors with the cached prior data. If the analysis of the cached data identifier directory indicates that other processors were updated with the cached prior data, the predetermined operations transmit the modified data to those identified processors and replace the cached prior data with the modified data.

Next, the predetermined operations determine if at least one other network node updated the accessed processor with the cached prior data. If another networked processor updated the accessed processor with the cached prior data, the predetermined operations transmit the modified data to the at least one other network processor and replace the cached prior data with the modified data. Finally, the predetermined operations issue an acknowledgement signal indicating modified data has replaced cached prior data. The acknowledgement signal is issue after all the cached prior data has been replaced by the modified data.

Another embodiment of the data modification aspect of the present invention is an executable program for a distributed hierarchical cache for a computer system comprised of a plurality of networked processors. The executable program comprises several portions of executable code that are targeted to performing specific tasks when executed on the computer system. The first executable code portion, when executed on the computer system, accesses a network processor and modifies cached prior data stored on the accessed network processor. The cached data modification request can come from a terminal attached to one of the networked processors, or be sent by a client processor that is attached to one of the networked processors.

The executable program further comprises a second executable code portion which, when executed on the computer system, searches a cached data identifier directory and determines if the accessed processor had previously updated other network processors with the cached prior data. If the analysis of the cached data identifier directory indicates that other processors were updated with the cached prior data, the executable program further comprises a third executable code portion which, when executed on the computer system, forwards the modified data to those processors and replaces the cached prior data with the modified data. The executable program further comprises a fourth executable code portion which, when executed on the computer system, determines if at least one other network node updated the accessed processor with the cached prior data. If the accessed processor was updated by another networked node, the fourth executable code portion transmits the modified data to the other network processor and replaces the cached prior data with the modified data.

The executable program further comprises a fifth executable code portion which, when executed on the computer system, issues an acknowledgement signal indicating modified data has replaced cached prior data. The fifth executable code portion issues the acknowledgement signal after all the cached prior data has been replaced with the modified data.

3. Data Invalidation

Alternatively, instead of modifying the cached data, the present invention can send an invalidation request to remove the cached data from the node. When the cached data is invalidated, the copy of the data is removed from the cache. If it is the only copy in all the networked caches, i.e., if there is no other cache where another copy is cached, the associated entry in the cached data identifier directory is also removed. If there are more copies in other caches, however, the entry is not removed from the cached data identifier directory. Invalidated cached data is not replaced in the cache. After invalidation, the next access to the same cached data will not find it in the cache. More generally, in order to maintain data consistency, all cached copies of the data should either be updated with the modified data, or all non-updated copies (stale data) should be invalidated from the caches. When a node receives an invalidation request from another node, instead of updating the cached data stored on the node, the cached data is invalidated. After the invalidation is complete, an acknowledgement signal is sent back to the node that transmitted the invalidation request. As used herein, the term “identified data” refers to the cached data that is identified by the invalidation request for removal from the network.

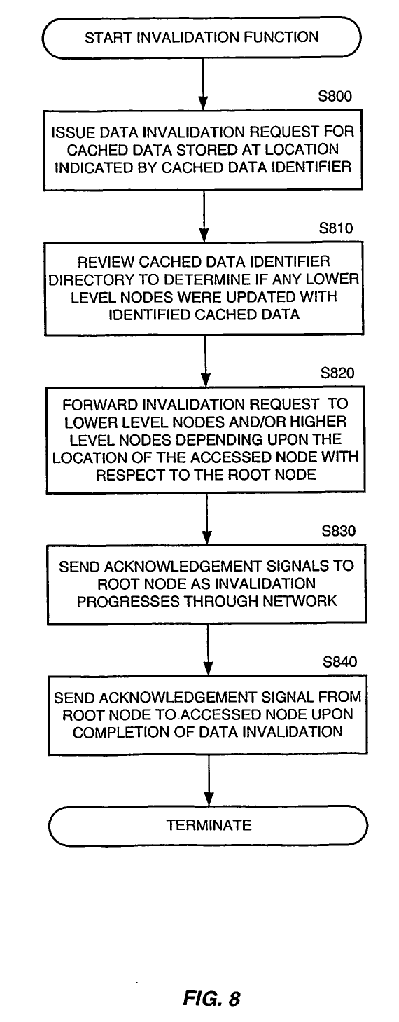

Referring to FIG. 8, the data invalidation scenario will be described in summary fashion. At S800, the identified data stored at accessed node is invalidated. At S810, the cached data identifier directory is consulted to determine which lower level nodes received the copies of the identified data. Please note that the terms “lower level node” and “higher level node” connote a direction through the network pathways with regard to the root node. At S820, the invalidation request is sent to higher level nodes as well as lower level nodes that have received copies of the identified data, depending upon the accessed node's location in the network with respect to the root node. At S830, as the invalidation of the identified data progresses, the various nodes caching the copies of the identified data send acknowledgement signals to the root node. At S840, when the root node has collected all the acknowledgement signals from the nodes in the network, the root node sends an acknowledgement to the user at the accessed node that the identified data has been successfully invalidated on all nodes.

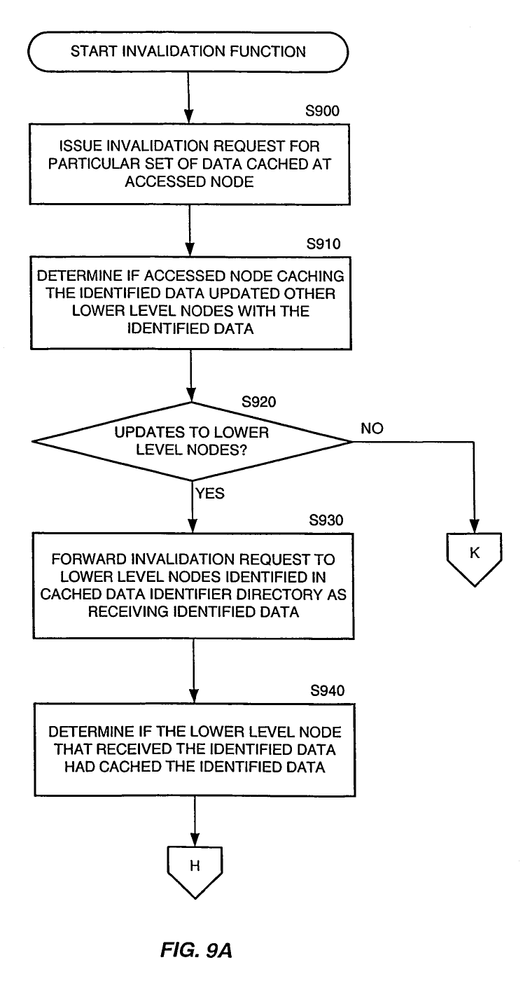

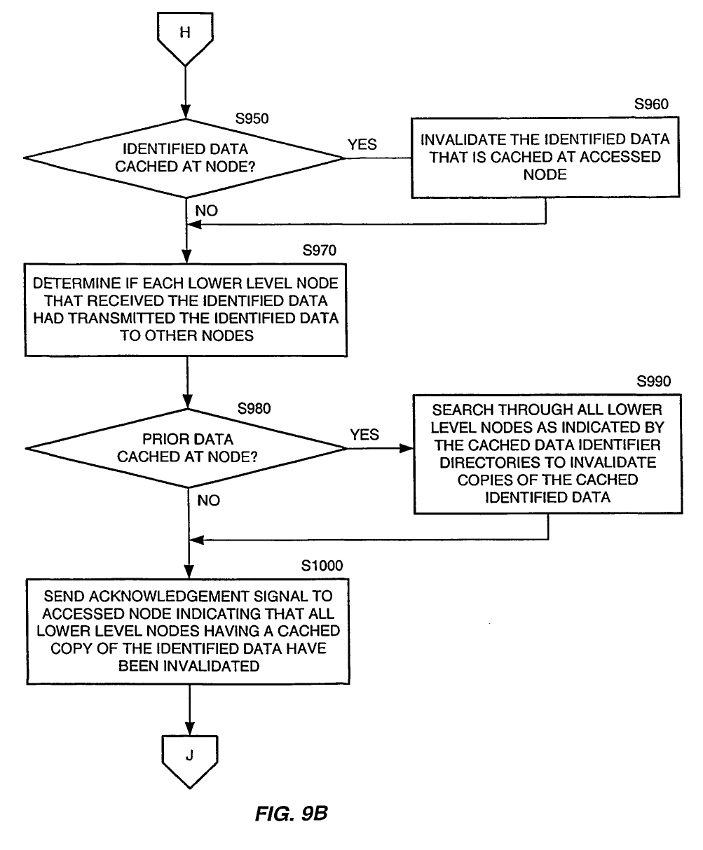

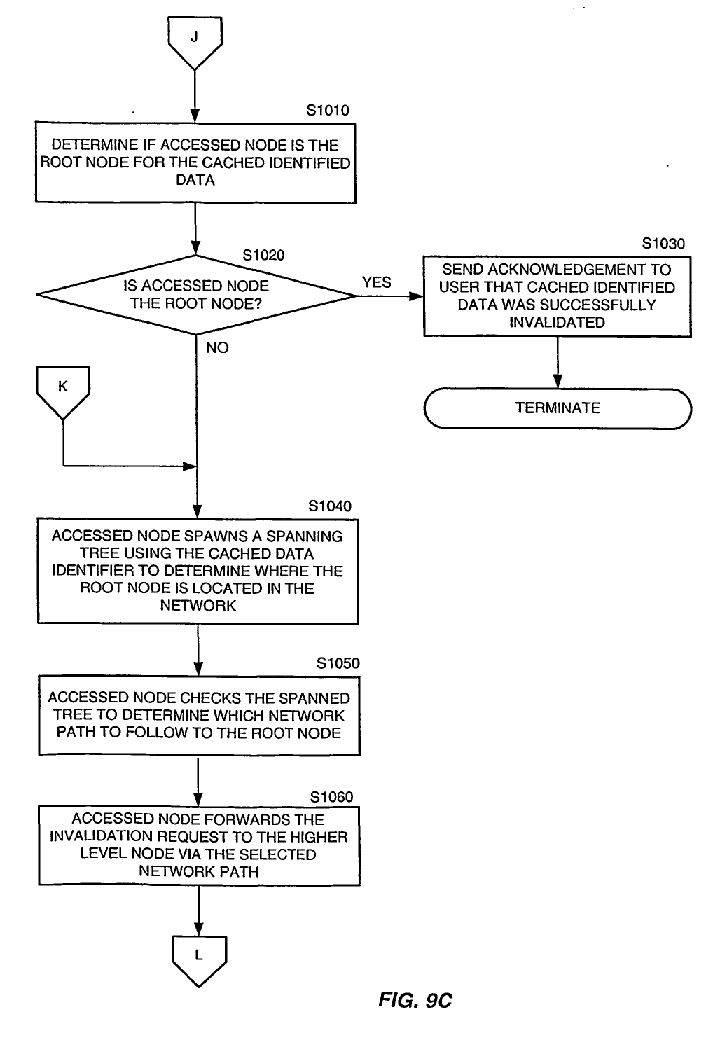

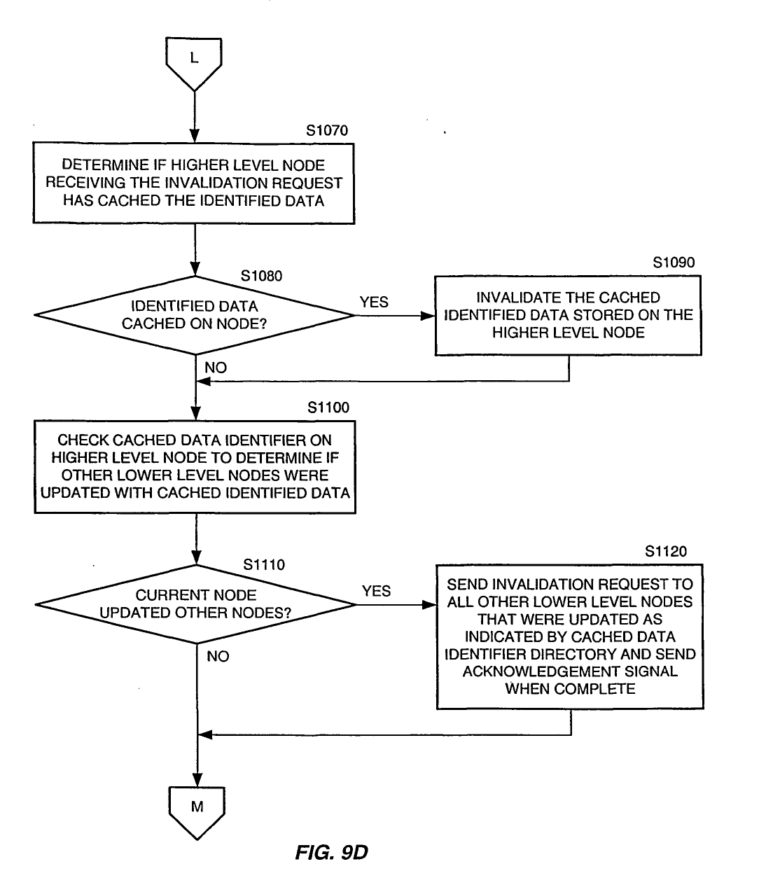

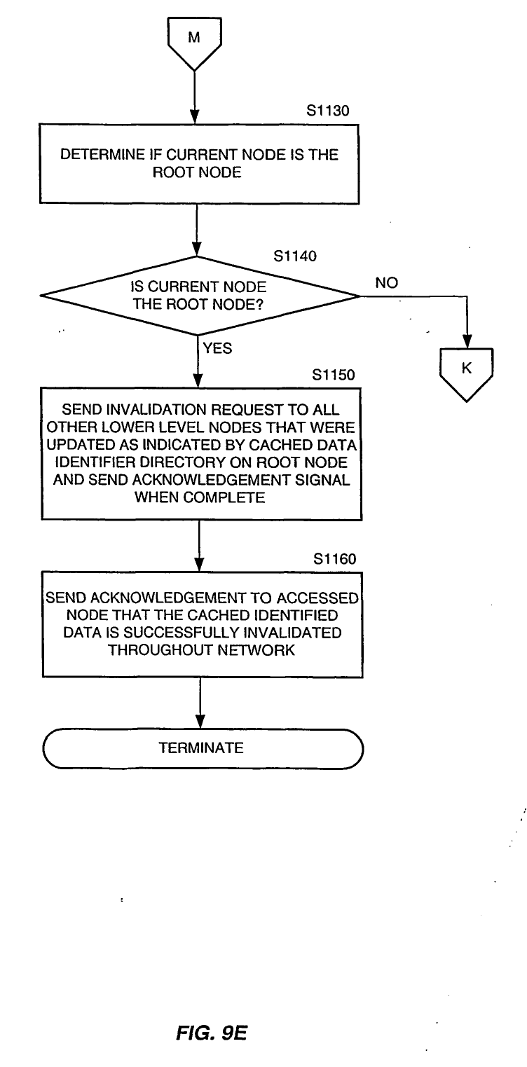

Referring to FIGS. 9A-9E, the data invalidation feature will be discussed in greater detail. Referring to FIG. 9A, at S900, the identified data cached at the accessed node is invalidated. If the accessed node is the root node, the data stored on the root node, cached on the root node, or stored at a location indirectly pointed to by the cached data identifier associated with the identified data is invalidated.

At S910, a determination is made whether the node caching the invalidated data updated any other lower level nodes with the identified data. The cached data identifier directory described earlier for keeping track of lower level nodes that are updated with identified data is used. As described previously, each node keeps a cached data identifier directory enumerating the lower level nodes that have received a copy of the identified data. If the cached data identifier directory indicates no lower level nodes received any copies of the identified data, the invalidation process proceeds to S1010.

If lower level nodes received copies of the identified data, at S930, the invalidation request is sent to the lower level nodes identified in the cached data identifier directory on the accessed node as having received the identified data. At S940, each lower level node receiving the invalidation request from the accessed node determines whether it has cached the identified data that was previously transmitted to it. If the lower level node has cached the identified data, at S960, the node invalidates the cached identified data.

Referring to FIG. 9B, at S970, each node determines if it transmitted the cached identified data to another level of lower level nodes. The data invalidation feature searches through the branches that spread out from a particular node to find all the copies of the cached identified data so that they can be invalidated. At S990, the invalidation process is repeated downtree until all nodes that are lower level nodes to the accessed node have been invalidated.

An acknowledgement signal process executes in parallel with the invalidation process. At S1000, once the invalidation process has been completed on all lower level nodes and their child nodes, the lower level nodes send an acknowledgement signal to the accessed node. This acknowledgment signal lets the accessed node that the invalidation process is complete. For example, referring to FIG. 3 and assuming the root node for a particular piece of cached data is node 31 and copies of the data are cached on nodes 27, 28, 29, 37 and 39, each of those nodes will transmit an acknowledgement signal to the root node 31. If the accessed node is node 28, and the cached identified data on node 28 is invalidated, then after node 28 sends out the invalidation request to node 27, it waits for an acknowledgment signal from node 27 indicating that node 27 and its lower level nodes have been invalidated. Since node 27 has updated other nodes (i.e., nodes 29, 37 and 39), it has to wait for acknowledgement signals from those nodes indicating that the original cached data was invalidated before sending its acknowledgement signal to node 28. If the accessed node is not the root node, the acknowledgement signal travels uptree with the invalidation request to the higher level nodes.

Referring to FIG. 9C, at S1010, the accessed node makes a determination of whether it is the root node for the particular piece of invalidated data. If the accessed node is the root node, at S1030, an acknowledgement signal is sent to the user that initiated the data invalidation indicating that the invalidation was successful.

If the accessed node is not the root node, then the accessed node must have received the cached identified data from a higher level node (i.e., at least one other node in the pathway between the accessed node and the root node for the cached identified data). The cached data identifier stored in the cached data identifier directory on the accessed node contains the identification of the root node that stores the identified data. If the accessed node is not the root node, at S1040, the accessed node spans a spanning tree to determine where in the network the root node for the identified data is located. At S1050, the accessed node checks the spanned tree to determine which network path to follow to the root node. Please note that for some network architectures, there is the possibility of multiple network paths, and therefore the most direct path to the root node should be followed. At S1060, the accessed node forwards the invalidation request to the selected higher level node using the selected network path.

Referring to FIG. 9D, at S1070, after receiving the invalidation request, the higher level node checks to see if it has cached the identified data. If so, at S1090, the higher level node invalidates the cached identified data. At S1100, the higher level node determines whether it updated other lower level nodes with the identified data by examining the cached data identifier stored on the higher level node. This is done to ensure all the branches of the network are checked for identified data that was transmitted to other nodes further downtree. If the higher level node updated other lower level nodes with the identified data, at S1120, the higher level node starts the invalidating process for lower level nodes described above, and waits for an acknowledgement signal from the lower level nodes that the invalidating process is complete.

Referring to FIG. 9E, at S1130, the current node determines if this is the root node. If the node is not the root node, the higher level node spans a spanning tree to determine its network relationship to the root node. The uptree invalidating process is continued until the root node is reached and the identified data stored on the root node is invalidated, and the appropriate acknowledgement signals are sent back to the root node. It is possible that when the root node has been reached and invalidated, it has other lower level nodes that received the identified data and that have not yet been invalidated. Therefore, at S1150, the invalidation process proceeds down those network branches until all the copies of the cached identified data have been located and invalidated.

At S1160, when the root node has received all the acknowledgement signals from its lower level nodes, it forwards an acknowledgment signal to the accessed node that the invalidating process is complete. Typically, the accessed node sends an acknowledgment to the user that the modified data has been successfully invalidated on all other nodes that cached the identified data, and that the identified data stored on the root node has been invalidated as well.

Referring to FIG. 3, an invalidation scenario will be further described. This process is repeated both uptree as well as downtree in order to ensure all the cached identified data is invalidated. For purposes of this example, it is assumed that node 27 is the root node for the identified data. It is further assumed that node 28, node 30, node 36 and node 38 have cached a copy of the identified data.

As described above, a user accesses node 30 and invalidates one of the pieces of identified data cached on node 30. The cached data identifier directory is reviewed and the invalidation request is sent to node 38, since the directory indicates that node 38 received a copy of the identified data. Node 38 sends an acknowledgement signal to node 30 after it invalidates its cached identified data since there are no lower level nodes connected to node 38.

After the lower level node invalidation process is completed, node 30 spans the network to determine its higher level nodes in order to get to the root node. The spanning tree will indicate that the higher level node of node 30 is node 27. The cached-data identifier denotes that the root node for this particular piece of cached data is node 27. Node 30 forwards the invalidation request to node 27 along with the acknowledgement signal indicating that it and all its lower level nodes have been invalidated.

After node 27 invalidates the uncached identified data (as well as any cached copies that it may have), it checks its cached data identifier directory to determine if any of its other lower level nodes received a copy of the identified data. Its cached data identifier directory would indicate that, other than node 30, node 28 and node 29 (and indirectly node 36) received the identified data as well. The identified data cached on those nodes are invalidated and the nodes send acknowledgement signals back to node 27, which sends an acknowledgement signal to node 30 once it has received acknowledgement signals from all its lower level nodes. When node 30 receives the acknowledgement signals from node 27 and node 38, it sends a message to the user that the cached identified data was successfully invalidated throughout the network.

Another embodiment of the method provided by the present invention for method for invalidating data in a hierarchical distributed cache uses a hierarchical distributed cache spread across a plurality of networked nodes. Client processors that are attached to the networked node access each of the networked nodes. There can be multiple client processors attached to a single network node. A data cache and a cached data identifier directory is on each networked node. The invalidation method of the present invention accesses a network node via a client processor and issuing an invalidation request against cached identified data stored on the accessed network node. Next, the method searches the cached data identifier directory of the accessed node and determines if the accessed node had previously updated other network nodes with the cached identified data.

Next, if the cached data identifier directory indicates that other nodes were updated with the cached identified data, the method transmits the invalidation request to those networked nodes. In other words, the invalidation request is forwarded to the networked nodes comprising the hierarchical distributed cache that have received the cached identified data. The method next determines if at least one other network node updated the accessed node with the cached identified data. If affirmative, the method transmits the invalidation request to the at least one other network node that updated the accessed node with the cached identified data. Finally, once all the copies of the cached identified data have been invalidated, the method issues an acknowledgement signal to the accessed node indicating the cached identified data has been invalidated. The acknowledgement signal is received by the client processors.

Another embodiment of the invalidation function of the present invention is a computer system adapted for a distributed hierarchical cache. In general, the computer system comprises a plurality of processors (i.e., nodes) that are networked together in some fashion. Within the computer system, there is at least one memory that comprises software instructions that are adapted to enable the computer system to execute the invalidation function aspect of the present invention. The software instructions are adapted to enable the inputting a cached data invalidation request to one of the plurality of networked processors. As described above, the cached data invalidation request is associated with a cached data identifier.

Each processor in the network has a cached data identifier directory as described above. The software instructions are further adapted to access a network node and issue an invalidation request against cached identified data stored on the accessed network node. The software instructions are further adapted to search a cached data identifier directory on a network node and determine if the accessed node had previously updated other network nodes with the cached identified data. As described above, the adapted software instructions execute a search through the cached data identifier directory to determine if the cached data identifier associated with the invalidation request is present.

If the search by the adapted software instruction of the cached data identifier directory indicates that other nodes were updated with the cached identified data, the adapted software instructions transmit the invalidation request to those identified nodes. The software instructions are further adapted to determine if the at least one other network node updated the accessed node with the cached identified data. If the software instructions determine that the accessed node was updated by another node, the software instructions transmit the invalidation request to the other network node that updated the accessed node. Finally, the software instructions are further adapted to issue an acknowledgement signal indicating the cached identified data has been invalidated. This acknowledgement signal is issued after all copies of that cached identified data have been invalidated.

Another embodiment of the invalidation aspect of the present invention is a computer program product for a distributed hierarchical cache. The computer program product comprises software instructions that enable a computer system of networked processors to perform predetermined operations. The software instructions are borne on a computer readable medium (e.g., floppy disk, CD, ROM, etc.). The predetermined operations performed by the networked processors comprise receiving a cached data invalidation request to one of the plurality of networked processors. As described above, the cached data invalidation request is associated with a cached data identifier.

Each processor in the network has a cached data identifier directory as described above. The predetermined operations, performed by the networked processor that received the cached data invalidation request, will access a network processor and issue an invalidation request against cached identified data. The predetermined operations with searching a cached data identifier directory on the accessed processor and determine if the accessed processor had previously updated other network processors with the cached identified data. If the analysis of the cached data identifier directory indicates that other processors were updated with the cached identified data, the predetermined operations transmit the invalidation request to those processors identified by the cached data identifier directory as having received the cached identified data.

Next, the predetermined operations determine if at least one other network node updated the accessed processor with the cached identified data. If the accessed node was updated by another networked node, the predetermined operations transmit the invalidation request to the other network processor. Finally, the predetermined operations issue an acknowledgement signal indicating the cached identified data has been invalidated. This acknowledgement signal is issued after all copies of that cached identified data have been invalidated.

Another embodiment of the invalidation function aspect of the present invention is an executable program for a distributed hierarchical cache for a computer system comprised of a plurality of networked processors. The executable program comprises several portions of executable code that are targeted to performing specific tasks when executed on the computer system. The executable program comprises a first executable code portion, when executed on the computer system, accesses a network processor and issues an invalidation request against cached identified data stored on the accessed network processor. The executable program comprises a second executable code portion which, when executed on the computer system, searches a cached data identifier directory and determines if the accessed processor had previously updated other network processors with the cached identified data.

Next, if the cached data identifier directory indicates to the executable program that other processors were updated with the cached identified data, the executable program comprises a third executable code portion which, when executed on the computer system, forwards the invalidation request to those processors identified as receiving the cached identified data. The executable program comprises a fourth executable code portion which, when executed on the computer system, determines if the at least one other network node updated the accessed processor with the cached identified data. If the access processor was updated by another process, the fourth executable code portion transmits the invalidation request to the other network processor.

The executable program further comprises a fifth executable code portion which, when executed on the computer system, issues an acknowledgement signal indicating that cached identified data has been invalidated. The fifth executable code portion issues the acknowledgement signal after all copies of that cached identified data have been invalidated.

4. Data Coalescing

The present invention also provides a data coalescing feature. When multiple data modifications are being performed to a particular set of cached data, they can be combined into a single write operation. For example, assume that two different users have requested partial data modifications to the same set of cached data. The possibility exists that the two partial data modifications will arrive at the same node. If the difference in arrival time at the node is significant, the node will execute the two partial data modifications in the order that they are received at the node. If the difference in arrival time is close, the node will combine the two partial data modifications into a single modification.

The multiple partial data modifications must be such that they can be coalesced. In order to be coalesced, the data modifications must meet one of the following scenarios:

1. The partial data modifications are to the same piece of cached data. The partial data modifications are merged together, and the same portion of the cached data is modified. The size of the data modification is unchanged.

2. The partial data modifications are directed to different portions of the same piece of cached data and the different portions of the cached data overlap. In this scenario, the size of the coalesced data modification is increased so as to accommodate the data overlap.

3. The partial data modifications are directed to different portions of the cached data and the different portions of the cached data do not overlap. The partial data modifications are directed to the same block of cached data. Typically, the block size is the largest unit of data that can be written in a single write operation. The size of the combined data modification is increased to cover both data portions that would be modified by the partial data modifications if executed individually. The maximum size of the combined data modification is the maximum size of the data block.

As described above, two partial data modifications can be combined into a single partial data modification. However, there is no limit on the number of partial data modifications that could be combined into a single partial data modification. The only limiting factors will be the difference in arrival time of the partial data modifications at the node and whether the partial data modifications are directed to the same piece of cached data.

The foregoing description of the aspects of the invention has been presented for purposes of illustration and description. It is not intended to be exhaustive or to limit the invention to the precise form disclosed, and modifications and variations are possible in light of the above teachings or may be acquired from practice of the invention. The principles of the invention and its practical application were described in order to explain the invention to enable one skilled in the art to utilize the invention in various embodiments and with various modifications as are suited to the particular use contemplated.

Thus, while only certain aspects of the invention have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A method for searching a hierarchical distributed cache on a plurality of networked nodes, the method comprising:
inputting a cached data search request to one of the plurality of networked nodes;
searching a cached data identifier directory stored on the networked node that received the cached data search request and determining if the requested data is cached on the networked node that received the search request;
if the requested data is cached on the networked node that received the cached data search request, outputting an acknowledgement signal;
if the requested data is not cached on the networked node that received the cached data search request, transmitting the cached data search request to other nodes in the plurality of networked nodes and determining if the requested data is cached on the other nodes in the plurality of networked nodes by searching a cached data identifier directory of at least one other networked node; and
if the requested data is found cached on at least one of the other nodes in the plurality of networked nodes, retrieving the requested data from its storage location and transmitting the requested data to the networked node that received the cached data search request.

2. The method as claimed in claim 1, wherein transmitting the cached data search request to other nodes in the plurality of networked nodes further comprises spanning a network tree based upon a root node identifier in the cached data identifier associated with the cached data search request.

3. The method as claimed in claim 2, further comprising transmitting the cached data search request to another node based upon the spanned network tree.

4. The method as claimed in claim 1, wherein transmitting the requested data further comprises updating the cached data identifier directory on the transmitting node and each of the nodes in the pathway between the transmitting node and the networked node that received the cached data search request.

5. The method as claimed in claim 1, wherein transmitting the requested data further comprises caching the requested data on each node on the pathway between the transmitting node and the networked node that received the cached data search request.

6. A method for searching a hierarchical distributed cache, the hierarchical distributed cache spread across a plurality of networked nodes, wherein each of the networked nodes are accessed by client processors, and each of the networked nodes comprise a data cache and a cached data identifier directory, the method comprising:
receiving a cached data search request from a client processor of one of the plurality of networked nodes;
searching a cached data identifier directory of the networked node that received the cached data search request and determining if the requested data is cached on the networked node that received the search request;
if the requested data is cached on the networked node that received the cached data search request, outputting an acknowledgement signal to the client processor;
if the requested data is not cached on the networked node that received the search request, transmitting the cached data search request to at least one other node in the plurality of networked nodes and determining if the requested data is cached on at least one other networked node by searching a cached data identifier directory of at least one other networked node; and
if the requested data is found cached on at least one of the other networked node, retrieving the requested data from its storage location and transmitting the requested data to the networked node that received the cached data search request.

7. The method as claimed in claim 6, wherein transmitting the cached data search request to other nodes in the plurality of networked nodes further comprises spanning a network tree based upon a root node identifier in the cached data identifier associated with the cached data search request.

8. The method as claimed in claim 7, further comprising transmitting the cached data search request to another node based upon the spanned network tree.

9. The method as claimed in claim 6, wherein transmitting the requested data further comprises updating the cached data identifier directory on the transmitting node and each of the nodes in the pathway between the transmitting node and the networked node that received the cached data search request.

10. The method as claimed in claim 6, wherein transmitting the requested data further comprises caching the requested data on each node on the pathway between the transmitting node and the networked node that received the cached data search request.

11. The method as claimed in claim 6, wherein transmitting the requested data further comprising notifying the client processor and transmitting the requested data from the networked node that received the cached data search request to the client processor.

12. A method for searching a hierarchical distributed cache, the hierarchical distributed cache spread across a plurality of networked nodes, wherein each of the networked nodes are accessed by client processors, and each of the networked nodes comprise a data cache and a cached data identifier directory, each cached data identifier directory listing the cached data identifier associated with each piece of data in a node's data cached, the method comprising:
receiving a cached data search request from a client processor of one of the plurality of networked nodes, wherein the cached data search request identifies a cached data identifier to be located;
searching a cached data identifier directory of the networked node that received the cached data search request and determining if the requested cached data identifier is listed in the cached data identifier directory on the networked node that received the search request;
if the requested cached data identifier is listed in the cached data identifier directory on the networked node that received the cached data search request, outputting an acknowledgement signal to the client processor;
if the requested cached data identifier is not listed in the cached data identifier directory on the networked node that received the search request, transmitting the cached data search request to at least one other node in the plurality of networked nodes and determining if the requested cached data identifier is listed in the cached data identifier directory of at least one other networked node by searching a cached data identifier directory of at least one other networked node; and
if the requested cached data identifier is located on at least one of the other networked node, retrieving the requested data from its storage location indicated by the cached data identifier and transmitting the requested data to the networked node that received the cached data search request.

13. The method as claimed in claim 12, wherein transmitting the cached data search request to other nodes in the plurality of networked nodes further comprises spanning a network tree based upon a root node identifier in the cached data identifier associated with the cached data search request.

14. The method as claimed in claim 13, further comprising transmitting the cached data search request to another node based upon the spanned network tree.

15. The method as claimed in claim 12, wherein transmitting the requested data further comprises updating the cached data identifier directory on the transmitting node and each of the nodes in the pathway between the transmitting node and the networked node that received the cached data search request.

16. The method as claimed in claim 12, wherein transmitting the requested data further comprises caching the requested data on each node on the pathway between the transmitting node and the networked node that received the cached data search request.

17. The method as claimed in claim 12, wherein transmitting the requested data further comprising notifying the client processor and transmitting the requested data from the networked node that received the cached data search request to the client processor.

18. A computer system adapted for a distributed hierarchical cache, the computer system comprising:
a plurality of networked processors;
a memory comprising software instructions adapted to enable the computer system to perform:
inputting a cached data search request to one of the plurality of networked processors;
searching a cached data identifier directory stored on the networked processors that received the cached data search request and determining if the requested data is cached on the networked processor that received the search request;
if the requested data is cached on the networked processor that received the cached data search request, outputting an acknowledgement signal;
if the requested data is not cached on the networked processor that received the cached data search request, transmitting the cached data search request to other processors in the plurality of networked processors and determining if the requested data is cached on the other processors in the plurality of networked processors by searching a cached data identifier directory of at least one other networked processor; and
if the requested data is found cached on at least one of the other processors in the plurality of networked processors, retrieving the requested data from its storage location and transmitting the requested data to the networked processor that received the cached data search request.

19. The computer system as claimed in claim 18, wherein transmitting the cached data search request to other processors in the plurality of networked processors further comprises spanning a network tree based upon a root node identifier in the cached data identifier associated with the cached data search request.

20. The computer system as claimed in claim 19, further comprising transmitting the cached data search request to another processor based upon the spanned network tree.

21. The computer system as claimed in claim 18, wherein transmitting the requested data further comprises updating the cached data identifier directory on the transmitting processor and each of the processors in the pathway between the transmitting processor and the networked processor that received the cached data search request.

22. The computer system as claimed in claim 18, wherein transmitting the requested data further comprises caching the requested data on each processor on the pathway between the transmitting processor and the networked processor that received the cached data search request.

23. The computer system as claimed in claim 18, wherein the cached data search request is input to a networked processor from an attached client processor.

24. The computer system as claimed in claim 23, wherein transmitting the requested data further comprising notifying the client processor and transmitting the requested data from the networked node that received the cached data search request to the client processor.

25. A computer program product for a distributed hierarchical cache, the computer program product comprising:
software instructions for enabling a computer system of networked processors to perform predetermined operations, and a computer readable medium bearing the software instructions;
the predetermined operations comprising:
inputting a cached data search request to one of the plurality of networked processors;
searching a cached data identifier directory stored on the networked processors that received the cached data search request and determining if the requested data is cached on the networked processor that received the search request;
if the requested data is cached on the networked processor that received the cached data search request, outputting an acknowledgement signal;
if the requested data is not cached on the networked processor that received the cached data search request, transmitting the cached data search request to other processors in the plurality of networked processors and determining if the requested data is cached on the other processors in the plurality of networked processors by searching a cached data identifier directory of at least one other networked processor; and
if the requested data is found cached on at least one of the other processors in the plurality of networked processors, retrieving the requested data from its storage location and transmitting the requested data to the networked processor that received the cached data search request.

26. An executable program for a distributed hierarchical cache for a computer system comprised of a plurality of networked processors, the executable program comprising:
a first executable code portion which, when executed on a computer system, inputs a cached data search request to one of the plurality of networked processors;
a second executable code portion which, when executed on a computer system, searches a cached data identifier directory stored on the networked processors that received the cached data search request and determining if the requested data is cached on the networked processor that received the search request;
a third executable code portion which, when executed on a computer system, determines if the requested data is cached on the networked processor that received the cached data search request, outputting an acknowledgement signal;
a fourth executable code portion which, when executed on a computer system, determines if the requested data is not cached on the networked processor that received the cached data search request, transmitting the cached data search request to other processors in the plurality of networked processors and determining if the requested data is cached on the other processors in the plurality of networked processors by searching a cached data identifier directory of at least one other networked processor; and
a fifth executable code portion which, when executed on a computer system, determines if the requested data is found cached on at least one of the other processors in the plurality of networked processors, retrieving the requested data from its storage location and transmitting the requested data to the networked processor that received the cached data search request.

27. A method for updating data in a hierarchical distributed cache on a plurality of networked nodes, the method comprising:
accessing a network node and modifying cached prior data stored on the accessed network node;
searching a cached data identifier directory and determining if the accessed node had previously updated other network nodes with the cached prior data;
if the cached data identifier directory indicates that other nodes were updated with the cached prior data, transmitting the modified data to those nodes and replacing the cached prior data with the modified data; and
determining if the accessed node was updated by at least one other network node with the cached prior data, and if yes, transmitting the modified data to the at least one other network node and replacing the cached prior data with the modified data; and
issuing an acknowledgement signal indicating modified data has replaced cached prior data.

28. The method as claimed in claim 27, wherein issuing an acknowledgement signal comprises transmitting an acknowledgement signal from networked nodes that receive modified data to the networked node that transmitted the modified data.

29. The method as claimed in claim 27, wherein determining if the accessed node was updated by at least one other network node further comprises determining if the accessed node is a root node.

30. The method as claimed in claim 29, wherein determining if the accessed node was updated by at least one other network node further comprises transmitting the modified data to other networked nodes until the root node is reached.

31. The method as claimed in claim 30, wherein the method further comprises sending an acknowledgement from the root node to the accessed node upon receipt of the modified cached data at the root node.

32. The method as claimed in claim 27, wherein the modified data comprises a partial modification of the cached prior data that is transmitted to other networked nodes.

33. The method as claimed in claim 27, wherein the cached prior data on a network node that is receiving modified data is invalidated before the modified data is stored.

34. A method for updating data in a hierarchical distributed cache, the hierarchical distributed cache spread across a plurality of networked nodes, wherein each of the networked nodes are accessed by client processors, and each of the networked nodes comprise a data cache and a cached data identifier directory, the method comprising:
accessing a network node via a client processor and modifying cached prior data stored on the accessed network node;
searching the cached data identifier directory of the accessed node and determining if the accessed node had previously updated other network nodes with the cached prior data;
if the cached data identifier directory indicates that other nodes were updated with the cached prior data, transmitting the modified data to those nodes and replacing the cached prior data with the modified data; and
determining if the accessed node was updated by at least one other network node with the cached prior data, and if yes, transmitting the modified data to the at least one other network node and replacing the cached prior data with the modified data; and
issuing an acknowledgement signal to the accessed node indicating modified data has replaced cached prior data and receiving the acknowledgement signal at the client processor.

35. A method for updating data in a hierarchical distributed cache, the hierarchical distributed cache spread across a plurality of networked nodes, wherein each of the networked nodes are accessed by client processors, and each of the networked nodes comprise a data cache and a cached data identifier directory, each cached data identifier directory listing the cached data identifier associated with each piece of data in a node's data cached, the method comprising:
accessing a network node via a client processor attached to the accessed network node and modifying cached prior data stored on the accessed network node;
searching a cached data identifier directory for a cached data identifier associated with the cached prior data and determining if the accessed node had previously updated other network nodes with the cached prior data;
if the cached data identifier directory indicates that other nodes were updated with the cached prior data, forwarding the modified data to those nodes and replacing the cached prior data with the modified data; and
determining if the accessed node was updated by at least one other network node with the cached prior data, and if yes, forwarding the modified data to the at least one other network node and replacing the cached prior data with the modified data; and
issuing an acknowledgement signal to the accessed node indicating modified data has replaced cached prior data and receiving the acknowledgement signal at the client processor.

36. A computer system adapted for a distributed hierarchical cache, the computer system comprising:
a plurality of networked nodes;
a memory comprising software instructions adapted to enable the computer system to perform the steps of:
accessing a network node and modifying cached prior data stored on the accessed network node;
searching a cached data identifier directory and determining if the accessed node had previously updated other network nodes with the cached prior data;
if the cached data identifier directory indicates that other nodes were updated with the cached prior data, transmitting the modified data to those nodes and replacing the cached prior data with the modified data; and
determining if the accessed node was updated by at least one other network node with the cached prior data, and if yes, transmitting the modified data to the at least one other network node and replacing the cached prior data with the modified data; and
issuing an acknowledgement signal indicating modified data has replaced cached prior data.

37. The computer system as claimed in claim 36, wherein the software instructions are further adapted to send an acknowledgement signal from networked nodes that receive modified data to the networked node that transmitted the modified data.

38. The computer system as claimed in claim 36, wherein the software instructions are further adapted to determine if the accessed node was updated by at least one other network node further by determining if the accessed node is a root node.

39. The computer system as claimed in claim 37, wherein the software instructions are further adapted to transmit the modified data to other networked nodes until the root node is reached.

40. The computer system as claimed in claim 39, wherein the software instructions are further adapted to send an acknowledgement from the root node to the accessed node upon receipt of the modified cached data at the root node.

41. The computer system as claimed in claim 36, wherein the modified data comprises a partial modification of the cached prior data that is transmitted to other networked nodes.

42. The computer system as claimed in claim 36, wherein the software instructions are further adapted so a network node that is receiving modified data is invalidated before the modified data is stored.

43. A computer program product for modifying data on a distributed hierarchical cache, the computer program product comprising:
software instructions for enabling a computer system of networked processors to perform predetermined operations, and a computer readable medium bearing the software instructions;
the predetermined operations comprising:
accessing a network processor and modifying cached prior data stored on the accessed network processor;
searching a cached data identifier directory and determining if the accessed processor had previously updated other network processors with the cached prior data;
if the cached data identifier directory indicates that other processors were updated with the cached prior data, transmitting the modified data to those processors and replacing the cached prior data with the modified data; and
determining if the accessed processor was updated by at least one other network node with the cached prior data, and if yes, transmitting the modified data to the at least one other network processor and replacing the cached prior data with the modified data; and
issuing an acknowledgement signal indicating modified data has replaced cached prior data.

44. An executable program for modifying data on a distributed hierarchical cache for a computer system comprised of a plurality of networked processors, the executable program comprising:
a first executable code portion which, when executed on the computer system, accesses a network processor and modifies cached prior data stored on the accessed network processor under the direction of an operator;
a second executable code portion which, when executed on the computer system, searches a cached data identifier directory and determines if the accessed processor had previously updated other network processors with the cached prior data;
if the cached data identifier directory indicates that other processors were updated with the cached prior data, a third executable code portion which, when executed on the computer system, forwards the modified data to those processors and replaces the cached prior data with the modified data; and
a fourth executable code portion which, when executed on the computer system, determines if the accessed processor was updated by at least one other network node with the cached prior data, and if yes, transmits the modified data to the at least one other network processor and replaces the cached prior data with the modified data; and
a fifth executable code portion which, when executed on the computer system, issues an acknowledgement signal indicating modified data has replaced cached prior data.

45. A method for invalidating data in a hierarchical distributed cache on a plurality of networked nodes, the method comprising:
accessing a network node and issuing an invalidation request against the cached identified data stored on the accessed network node;
searching a cached data identifier directory and determining if the accessed node had previously updated other network nodes with the cached identified data;
if the cached data identifier directory indicates that other nodes were updated with the cached identified data, transmitting the invalidation request to those nodes; and
determining if the accessed node was updated by at least one other network node with the cached identified data, and if yes, transmitting the invalidation request to the at least one other network node; and
issuing an acknowledgement signal indicating the cached identified data is invalidated.

46. A method for invalidating data in a hierarchical distributed cache, the hierarchical distributed cache spread across a plurality of networked nodes, wherein each of the networked nodes are accessed by client processors, and each of the networked nodes comprise a data cache and a cached data identifier directory, the method comprising:
accessing a network node via a client processor and issuing an invalidation request against cached identified data stored on the accessed network node;
searching the cached data identifier directory of the accessed node and determining if the accessed node had previously updated other network nodes with the cached identified data;
if the cached data identifier directory indicates that other nodes were updated with the cached identified data, transmitting the invalidation request to those nodes; and
determining if the accessed node was updated by at least one other network node with the cached identified data, and if yes, transmitting the invalidation request to the at least one other network node; and
issuing an acknowledgement signal to the accessed node indicating the cached identified data has been invalidated and receiving the acknowledgement signal at the client processor.

47. A method for invalidating data in a hierarchical distributed cache, the hierarchical distributed cache spread across a plurality of networked nodes, wherein each of the networked nodes are accessed by client processors, and each of the networked nodes comprise a data cache and a cached data identifier directory, each cached data identifier directory listing the cached data identifier associated with each piece of data in a node's data cached, the method comprising:
accessing a network node via a client processor attached to an access node and issuing an invalidation request against cached identified data stored on the accessed network node;
searching the cached data identifier directory of the accessed node and determining if the accessed node had previously updated other network nodes with the cached identified data;
if the cached data identifier directory indicates that other nodes were updated with the cached identified data, transmitting the invalidation request to those nodes; and
determining if the accessed node was updated by at least one other network node with the cached identified data, and if yes, transmitting the invalidation request to the at least one other network node; and
issuing an acknowledgement signal to the accessed node indicating the cached identified data has been invalidated and receiving the acknowledgement signal at the client processor.

48. A computer system adapted for a distributed hierarchical cache, the computer system comprising:
a plurality of networked nodes;
a memory comprising software instructions adapted to enable the computer system to perform the steps of:
accessing a network node and issuing an invalidation request against cached identified data stored on the accessed network node;
searching a cached data identifier directory and determining if the accessed node had previously updated other network nodes with the cached identified data;
if the cached data identifier directory indicates that other nodes were updated with the cached identified data, transmitting the invalidation request to those nodes; and
determining if the accessed node was updated by at least one other network node with the cached identified data, and if yes, transmitting the invalidation request to the at least one other network node; and
issuing an acknowledgement signal indicating the cached identified data has been invalidated.

49. A computer program product for invalidating data on a distributed hierarchical cache, the computer program product comprising:
software instructions for enabling a computer system of networked processors to perform predetermined operations, and a computer readable medium bearing the software instructions;
the predetermined operations comprising:
accessing a network processor and issuing an invalidation request against cached identified data stored on the accessed network processor;
searching a cached data identifier directory and determining if the accessed processor had previously updated other network processors with the cached identified data;
if the cached data identifier directory indicates that other processors were updated with the cached identified data, transmitting the invalidation request to those processors; and
determining if the accessed processor was updated by at least one other network node with the cached identified data, and if yes, transmitting the invalidation request to the at least one other network processor; and
issuing an acknowledgement signal indicating the cached identified data has been invalidated.

50. An executable program for invalidating data on a distributed hierarchical cache for a computer system comprised of a plurality of networked processors, the executable program comprising:
a first executable code portion which, when executed on the computer system, accesses a network processor and issues an invalidation request against cached identified data stored on the accessed network processor;
a second executable code portion which, when executed on the computer system, searches a cached data identifier directory and determines if the accessed processor had previously updated other network processors with the cached identified data;
if the cached data identifier directory indicates that other processors were updated with the cached identified data, a third executable code portion which, when executed on the computer system, forwards the invalidation request to those processors; and
a fourth executable code portion which, when executed on the computer system, determines if the accessed processor was updated by at least one other network node with the cached identified data, and if yes, transmitting the invalidation request to the at least one other network processor; and
a fifth executable code portion which, when executed on the computer system, issues an acknowledgement signal indicating that cached identified data has been invalidated.
